(19) United States
(12) Patent Application Publication
(10) Pub. No.: US 2026/0245357 A1
(43) Pub. Date: Aug. 20, 2026

(54) IMAGE PROCESSING METHOD AND APPARATUS, ELECTRONIC DEVICE, COMPUTER-READABLE STORAGE MEDIUM, AND COMPUTER PROGRAM PRODUCT

(71) Applicant: TENCENT TECHNOLOGY (SHENZHEN) COMPANY LIMITED, Shenzhen (CN)

(72) Inventors: Xiaoyi ZHANG, Shenzhen (CN); Jinkun HOU, Shenzhen (CN); Runzeng GUO, Shenzhen (CN); Shaoming WANG, Shenzhen (CN); Zhiqiang ZHANG, Shenzhen (CN); Qi CUI, Shenzhen (CN)

(73) Assignee: TENCENT TECHNOLOGY (SHENZHEN) COMPANY LIMITED, Shenzhen (CN)

(21) Appl. No.: 19/646,723

(22) Filed: Apr. 14, 2026

Related U.S. Application Data
(63) Continuation of application No. PCT/CN2025/077336, filed on Feb. 14, 2025.

(30) Foreign Application Priority Data
Feb. 18, 2024 (CN) 202410183655.0

(51) Int. Cl. G06V 10/98; G06T 5/70; G06T 7/00; G06T 7/13; G06V 10/77; G06V 10/82; G06V 40/10

(52) U.S. Cl. CPC G06V 10/993; G06T 5/70; G06T 7/0002; G06T 7/13; G06V 10/7715; G06V 10/82; G06V 40/10; G06T 2207/20084; G06T 2207/30168; G06T 2207/30242

(57) ABSTRACT

A method, apparatus, and computer-readable storage medium for an improved image processing method applied to an electronic device is provided. The method incudes acquiring a first image including a particular part of a target object.. The first image is collected based on a first focus parameter, and the particular part includes biometric features of the target object. A state of the particular part is detected when the first image is collected. Edge detection on the particular part in the first image is performed to obtain an edge area of the particular part. Sharpness of the edge area is detected. The first focus parameter is adjusted based on the sharpness to obtain a second focus parameter, and the second focus parameter is configured to replace the first focus parameter to collect a second image including the particular part of the target object.

### CROSS REFERENCE TO RELATED APPLICATION

This application is a bypass continuation application of International Patent Application No. PCT/CN2025/077336, filed on Feb. 14, 2025, which claims priority to and is based on Chinese Patent Application No. 202410183655.0, filed on Feb. 18, 2024, the disclosures of which are incorporated herein in their entireties by reference.

### FIELD

The present disclosure relates to computer vision technologies, and in particular, to an image processing method and apparatus, an electronic device, a computer-readable storage medium, and a computer program product.

### BACKGROUND

Biometric features are widely applied to identity verification in various scenes, such as electronic device login, financial services (electronic payment), and medical services. In the related art, when identity verification is performed on a target object, an image including biometric features of a particular part of the target object needs to be collected. However, during collection, the target object usually cannot be ensured to be absolutely static, which results in poor quality of the collected image, such as blurring, thereby affecting the efficiency and precision of recognition.

### SUMMARY

Provided are an image processing method and apparatus, an electronic device, a computer-readable storage medium, and a computer program product, capable of efficiently collecting a sharp image of a particular part including biometric features of a target object.

According to an aspect of some embodiments of the present disclosure, an image processing method applied to an electronic device includes acquiring a first image including a particular part of a target object, the first image being collected based on a first focus parameter, and the particular part including biometric features of the target object; detecting a state of the particular part when the first image is collected; performing, when the state of the particular part is a motion state, edge detection on the particular part in the first image to obtain an edge area of the particular part; detecting sharpness of the edge area; and adjusting the first focus parameter based on the sharpness to obtain a second focus parameter, the second focus parameter being configured to replace the first focus parameter to collect a second image comprising the particular part of the target object. The method further includes dividing the second image to obtain a plurality of first local images; performing feature extraction on the plurality of first local images to obtain a plurality of first local features; dividing a pre-registered image in an image database to obtain a plurality of second local images; performing feature extraction on the plurality of second local images to obtain a plurality of second local features; determining, for each first local feature, a local similarity between the first local feature and a corresponding second local feature; determining a sum of a plurality of local similarities; and determining a ratio of the sum to a quantity of the plurality of first local images, using the ratio as a similarity between the second image and the pre-registered image, and using a pre-registered image having a highest similarity as an image belonging to a same object as the second image.

According to an aspect of some embodiments of the present disclosure, an image processing apparatus including at least one memory configured to store program code; and at least one processor configured to read the program code and operate as instructed by the program code, the program code including: an acquisition code configured to cause the at least one of the at least one processor to acquire a first image including a particular part of a target object, the first image being collected based on a first focus parameter, and the particular part including biometric features of the target object; a detection code configured to cause the at least one of the at least one processor to detect a state of the particular part when the first image is collected; perform, when the state of the particular part being a motion state, edge detection on the particular part in the first image to obtain an edge area of the particular part; and detect sharpness of the edge area; and an adjustment code configured to cause the at least one of the at least one processor to adjust the first focus parameter based on the sharpness to obtain a second focus parameter, the second focus parameter being configured to replace the first focus parameter to collect a second image comprising the particular part of the target object.

According to an aspect of some embodiments of the present disclosure, a non-transitory computer-readable storage medium, storing computer code which, when executed by at least one processor, causes the at least one processor to at least: acquire a first image comprising a particular part of a target object, the first image being collected based on a first focus parameter, and the particular part comprising biometric features of the target object; detect a state of the particular part when the first image is collected; perform, when the state of the particular part is a motion state, edge detection on the particular part in the first image to obtain an edge area of the particular part; detect sharpness of the edge area; and adjust the first focus parameter based on the sharpness to obtain a second focus parameter, the second focus parameter being configured to replace the first focus parameter to collect a second image comprising the particular part of the target object.

The embodiments of this application have the following beneficial effects.

The state of the particular part in the first image is detected. If the particular part is in the motion state when the first image is collected, the sharpness of the particular part including the biometric features is positioned by edge detection, and the first focus parameter used when the first image is adopted is adjusted according to the sharpness to obtain the second focus parameter, so as to collect the second image through the second focus parameter, thereby timely and adaptively adjusting a focus parameter collected next time according to the particular part in a previous image and according to the state of the particular part when the previous image is collected. The entire process requires no manual intervention, ensuring that a sharp image may be collected when the particular part is moving, and improving the sharpness and efficiency of image collection.

### BRIEF DESCRIPTION OF DRAWINGS

To describe the technical solutions in the embodiments of the present disclosure more clearly, the following briefly describes the accompanying drawings required for describing the embodiments of the present disclosure. The accompanying drawings in the following description show only some embodiments of the present disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic structural diagram of an image processing system 100 according to an embodiment of the present disclosure.

FIG. 2 is a schematic structural diagram of a server 200 according to an embodiment of the present disclosure.

FIG. 3A is a first schematic flowchart of an image processing method according to an embodiment of the present disclosure.

FIG. 3B is a second schematic flowchart of an image processing method according to an embodiment of the present disclosure.

FIG. 3C is a third schematic flowchart of an image processing method according to an embodiment of the present disclosure.

FIG. 3D is a fourth schematic flowchart of an image processing method according to an embodiment of the present disclosure.

FIG. 3E is a fifth schematic flowchart of an image processing method according to an embodiment of the present disclosure.

FIG. 3F is a sixth schematic flowchart of an image processing method according to an embodiment of the present disclosure.

FIG. 3G is a seventh schematic flowchart of an image processing method according to an embodiment of the present disclosure.

FIG. 3H is an eighth schematic flowchart of an image processing method according to an embodiment of the present disclosure.

FIG. 3I is a ninth schematic flowchart of an image processing method according to an embodiment of the present disclosure.

FIG. 3J is a tenth schematic flowchart of an image processing method according to an embodiment of the present disclosure.

FIG. 3K is an eleventh schematic flowchart of an image processing method according to an embodiment of the present disclosure.

FIG. 3L is a twelfth schematic flowchart of an image processing method according to an embodiment of the present disclosure.

FIG. 3M is a thirteenth schematic flowchart of an image processing method according to an embodiment of the present disclosure.

FIG. 3N is a fourteenth schematic flowchart of an image processing method according to an embodiment of the present disclosure.

FIG. 3O is a fifteenth schematic flowchart of an image processing method according to an embodiment of the present disclosure.

FIG. 4 is a schematic structural diagram of an AlexNet model according to an embodiment of the present disclosure.

FIG. 5 is a schematic structural diagram of a neural network model according to an embodiment of the present disclosure.

FIG. 6 is a schematic diagram of a principle of a target recognition algorithm according to an embodiment of the present disclosure.

FIG. 7 is a schematic diagram of a positive gradient direction and a negative gradient direction of a current pixel according to an embodiment of the present disclosure.

FIG. 8 is an overall architectural diagram of iris recognition according to an embodiment of the present disclosure.

FIG. 9 is a schematic diagram of a principle of focus parameter adjustment according to an embodiment of the present disclosure.

The foregoing “first” and “second” are merely used for distinguishing different solutions, and do not represent superiorities of the solutions or priorities in an implementation process.

### DETAILED DESCRIPTION

To make the objectives, technical solutions, and advantages of the present disclosure clearer, the present disclosure will be described in further detail below with reference to the accompanying drawings. The described embodiments are not to be considered as a limitation to the present disclosure. All other embodiments obtained by a person skilled in the art without inventive efforts shall fall within the protection scope of the present disclosure.

The term, involved in the following description, “some embodiments” describes subsets of all possible embodiments. However, “some embodiments” may be the same subset or different subsets of all the possible embodiments, and may be combined with each other without conflict.

The term, involved in the following description, “first/second/third” is merely intended to distinguish similar objects rather than describe specific orders. The “first/second/third” is interchangeable in proper circumstances to enable the embodiments of the present disclosure described herein to be implemented in other orders than those illustrated or described herein.

In the embodiments of the present disclosure, the term “module” or “unit” refers to a computer program having a predetermined function or a part of the computer program, works together with other relevant parts to achieve a predetermined objective, and may be all or partially implemented through software, hardware (such as a processing circuit or a memory), or a combination thereof. Similarly, one processor (or a plurality of processors or memories) may be configured to implement one or more modules or units. In addition, each module or unit may be a part of an overall module or unit containing a function of the module or unit.

Unless otherwise specified, “at least one” described below refers to one or more, and “a plurality of” may refer to two or more.

During example application of the relevant data collection and processing in the embodiments of the present disclosure, the informed consent or individual consent of a personal information subject needs to be acquired in strict accordance with the requirements of relevant laws and regulations, and the subsequent data use and processing behavior is carried out within the scope of authorization of laws and regulations and the personal information subject.

Unless otherwise defined, meanings of all technical and scientific terms used in the embodiments of the present disclosure are the same as those understood by a person skilled in the technical field. Terms used in the embodiments of the present disclosure are merely intended to describe objectives of the embodiments of the present disclosure, but are not intended to limit the present disclosure.

Before the embodiments of the present disclosure are further described in detail, nouns and terms involved in the embodiments of the present disclosure are described. The nouns and terms involved in the embodiments of the present disclosure are applicable to the following explanations.
1) A particular part refers to a specified part of a target object included in an image. The part includes at least one of the following: a palm, a sole, a pupil, and a face.
2) Biometric features refer to physiological features unique to the human body, such as a palm print, an iris, a facial feature, and a gait.
3) An edge area refers to a curve formed by connecting a plurality of pixels on a contour of the particular part.
4) A focus parameter refers to a parameter configured for adjusting a position, a shape, or other characteristics of a lens or an image sensor during photography or image processing to ensure that an image can be sharply presented. The focus parameter includes the following aspects.

A focus distance refers to a distance from a lens to a captured object. The focus distance determines whether an object is sharp in an image. If the focus distance is correctly set, the object is sharply presented in the image. If it is incorrectly set, the object may be blurred.

An aperture is an apparatus in the lens that controls the amount of light entering, and is represented by the f-number. The size of the aperture not only affects the amount of light entering, but also affects the depth of field. The depth of field refers to a range of sharpness in an image from the foreground to the background. A larger aperture (a smaller f-number) reduces the depth of field, making the background blurred. A smaller aperture (a larger f-number) increases the depth of field, making the foreground and the background sharper.

A focal length is an optical characteristic of a lens, and determines a viewing angle and a magnification of an image. A long-focal-length lens (such as a telephoto lens) has a narrow viewing angle and a high magnification, and a short-focal-length lens (such as a wide-angle lens) has a wide viewing angle and a low magnification.

A focus mode determines how the camera adjusts the focus distance. Common focus modes include manual focus (MF), auto focus (AF), and semi-auto focus. The AF may further be divided into one-shot AF, continuous AF, and the like.

A focus area refers to an area selected by the camera for focusing during AF. Different focus area modes enable the camera to focus at different positions, such as center focus, multi-point focus, and face-priority focus.

Fine-tuning: in some advanced cameras, a user may perform fine tuning on focus to correct a focus deviation between a lens and a camera, thereby ensuring the sharpness of an image.
5) A membership degree is a concept in fuzzy set theory. It represents a probability that sharpness belongs to a preset reference sharpness set and is configured to measure the association strength between the sharpness and the preset reference sharpness set. The membership degree is a real number having a value range of [0, 1], where 0 indicates that the sharpness does not belong to the preset reference sharpness set, 1 indicates that the sharpness completely belongs to the preset reference sharpness set, and a value ranging from 0 to 1 indicates a degree to which the sharpness belongs to the preset reference sharpness set.
6) A focus parameter step size refers to a maximum value of a focus parameter adjustable by the image sensor in a single image collection process.
7) An adjustment coefficient refers to a weight of the focus parameter step size in a process of adjusting a first focus parameter to obtain a second focus parameter. For example, Second Focus Parameter=First Focus Parameter+Adjustment Coefficient*Focus Parameter Step Size. The adjustment coefficient is the weight of the focus parameter step size.
8) A crisp membership degree represents a probability that the sharpness belongs to the preset reference sharpness set in a crisp dimension. For example, a value range of the preset reference sharpness set is 0 to 100, where 0 represents blurred, and 100 represents sharp. When the sharpness is 60, the crisp membership degree=60/100=0.6.
9) A fuzzy membership degree represents a probability that the sharpness belongs to the preset reference sharpness set in a fuzzy dimension. For example, a value range of the preset reference sharpness set is 0 to 100, where 0 represents blurred, and 100 represents sharp. When the sharpness is 60, the fuzzy membership degree=1−(60/100)=0.4.
10) A pre-registered image refers to image data that is pre-stored in an image database and that is configured for comparison and verification. These images are captured or uploaded during registration of a user (that is, the target object), and include biometric features such as a face, a fingerprint, and an iris of the user, or pictures of the user in specific scenes. The main function of the pre-registered image is to serve as a reference image in a subsequent verification process and to be compared with a newly captured second image to confirm a user identity or match a particular object.
11) “In response to” is configured to indicate a condition or state on which a performed operation depends. When the condition or state on which the performed operation depends is satisfied, one or more performed operations may be performed in real time, or may be performed after a set delay. Unless particularly described, there is no limitation to the order in which a plurality of operations are performed.
12) A human-computer interaction interface is an interface configured to provide a human-computer interaction function/an interface configured to present an image.

For example, a graphical user interface (GUI) presents, for example, an augmented reality (AR) interface, a virtual reality (VR) interface, a voice user interface (VUI), an interactive projection interface (displaying information on a plane using a projection technology), an eye-tracking detection interface (an interface controlled by detecting a line of sight of a user), a holographic interface (a three-dimensional hologram formed by projecting images through holographic projection technology, allowing stereoscopic images to be viewed without special glasses), a multimodal interface (an interaction interface combining multiple interaction manners, such as tactile, visual, and auditory), and a brain-machine interface (BMI).

In the related art, an image is acquired using a fixed focus parameter, and even if a state of a particular part of a target object included in the image constantly changes, a same focus parameter is maintained for image collection.

Based on the foregoing analysis, the applicant finds that in an image processing method in the related art, when the state of the particular part is a motion state, a focus parameter cannot be dynamically adjusted to obtain a sharp image. For the foregoing technical problem, the embodiments of the present disclosure provide an image processing method, capable of efficiently collecting a sharp image of the particular part including biometric features of the target object.

The embodiments of the present disclosure provide an image processing method and apparatus, an electronic device, a computer-readable storage medium, and a computer program product, capable of efficiently collecting a sharp image of the particular part including biometric features of the target object. Exemplary application of the electronic device provided in the embodiments of the present disclosure is described below. The electronic device provided in the embodiments of the present disclosure may be implemented as various types of user terminals such as a notebook computer, a tablet computer, a desktop computer, a set-top box, a mobile device (for example, a mobile phone, a portable music player, a personal digital assistant, a dedicated message device, and a portable game device), a smartphone, a smart speaker, a smart watch, a smart television, or an in-vehicle terminal, or may be implemented as a server. Exemplary application in which the electronic device is implemented as a server is described below.

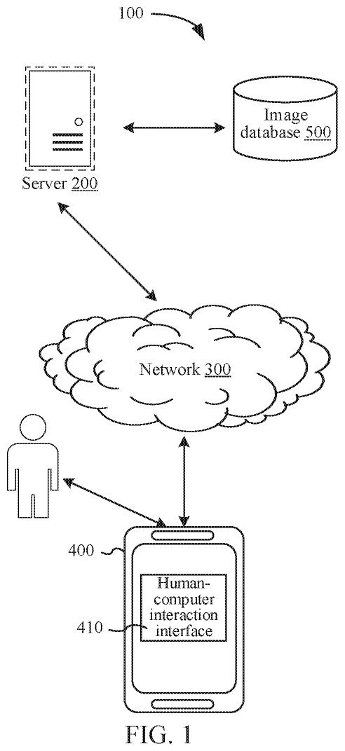

FIG. 1 is a schematic structural diagram of an image processing system 100 according to an embodiment of the present disclosure. To support an image processing application, a terminal 400 is connected to a server 200 through a network 300. Data transmission may be performed between the server 200 and an image database 500. The network 300 may be a wide area network, a local area network, or a combination thereof.

The terminal 400 is configured to collect a first image and transmit the first image to the server 200. The server 200 is configured to receive the first image, adjust a first focus parameter corresponding to the first image by detecting the first image, to obtain a second focus parameter, and transmit the second focus parameter to the terminal 400, so that the terminal 400 collects a second image according to the second focus parameter and displays the second image on a human-computer interaction interface 410. After collecting the second image, the terminal 400 may transmit the second image to the server 200, so that the server 200 performs image recognition through a vector database 500 to obtain a target image.

Using an instant messaging scene as an example, when the terminal 400 is in a video call with another terminal, the terminal 400 is configured to collect a first image and transmit the first image to the server 200. The server 200 adjusts a focus parameter used by the collected first image, thereby collecting a second image.

Using an electronic payment scene as an example, when payment is completed by detecting a particular part of a target object, the terminal 400 is configured to collect a first image including the particular part of the target object and transmit the first image to the server 200. The server 200 adjusts a focus parameter used by the collected first image, thereby collecting a second image including the particular part of the target object.

Using a medical service scene as an example, when particular part detection is performed on a patient (target object), the terminal 400 is configured to collect a first image including the particular part of the target object and transmit the first image to the server 200. The server 200 adjusts a focus parameter used by the collected first image, thereby collecting a second image including the particular part of the target object.

In some embodiments, the server 200 may be an independent physical server, may be a server cluster or a distributed system including a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform. The terminal 400 may be a smartphone, a tablet computer, a notebook computer, a desktop computer, a smart speaker, a smart watch, an in-vehicle terminal, or the like, but is not limited thereto. The terminal may be directly or indirectly connected to the server in a wired or wireless communication manner. This is not limited in the embodiments of the present disclosure.

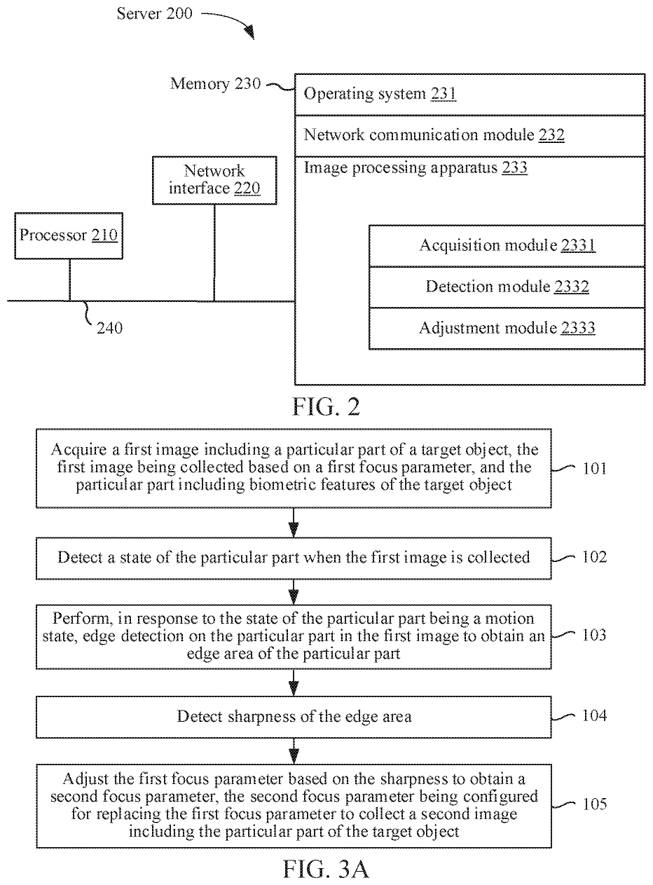

FIG. 2 is a schematic structural diagram of a server 200 according to an embodiment of the present disclosure. The server 200 shown in FIG. 2 includes: at least one processor 210, a memory 230, and at least one network interface 220. Components in the server 200 are coupled together through a bus system 240. The bus system 240 is configured to implement connection and communication between the components. In addition to a data bus, the bus system 240 further includes a power bus, a control bus, and a state signal bus. However, for clear description, all types of buses in FIG. 2 are marked as the bus system 240.

The processor 210 may be an integrated circuit chip with a signal processing capability, such as a general-purpose processor, a digital signal processor (DSP), or another programmable logic device, discrete gate, transistor logic device, or discrete hardware component. The general-purpose processor may be a microprocessor, any conventional processor, or the like.

The memory 230 may be removable, non-removable, or a combination thereof. Exemplary hardware devices include a solid-state memory, a hard disk drive, a compact disc (CD) drive, and the like. The memory 230 alternatively includes one or more storage devices physically located away from the processor 210.

The memory 230 includes a volatile memory or a non-volatile memory, or may include both the volatile memory and the non-volatile memory. The non-volatile memory may be a read only memory (ROM), and the volatile memory may be a random access memory (RAM). The memory 230 described in this embodiment of the present disclosure is intended to include any suitable type of memory.

In some embodiments, the memory 230 can store data to support various operations. Examples of the data include a program, a module, and a data structure, or their subsets or supersets, which are exemplified below.

An operating system 231 includes a system program configured to process various basic system services and performing hardware-related tasks, such as a framework layer, a core library layer, or a driver layer, to implement various basic businesses and process the hardware-based tasks.

A network communication module 232 is configured to connect to other electronic devices via one or more (wired or wireless) network interfaces 220. The exemplary network interfaces 220 include Bluetooth, wireless fidelity (WiFi), a universal serial bus (USB), and the like.

In some embodiments, the apparatus provided in the embodiments of the present disclosure may be implemented in a software manner. FIG. 2 shows an image processing apparatus 233 stored in the memory 230. The image processing apparatus 233 may be software in the form of a program, a plug-in, or the like, and includes the following software modules: an acquisition module 2331, a detection module 2332, and an adjustment module 2333. These modules are logical, and therefore may be arbitrarily combined or further split according to implemented functions. The functions of the modules will be described below.

In some embodiments, the terminal or the server may implement the image processing method provided in embodiments of the present disclosure by running various computer-executable instructions or computer programs. For example, the computer-executable instruction may be a microprogram-level command, a machine instruction, or a software instruction. The computer program may be a native program or a software module in an operating system, may be a native application (APP), i.e., a program that needs to be installed in the operating system to run, such as a payment APP or an instant messaging APP, or may be a mini program that may be embedded in any APP, i.e., a program that only needs to be downloaded into a browser environment to run. In summary, the foregoing computer-executable instruction may be an instruction in any form, and the foregoing computer program may be an APP, a module, or a plug-in in any form.

The image processing method provided in the embodiments of the present disclosure is described with reference to the exemplary application and implementations of the server provided in the embodiments of the present disclosure.

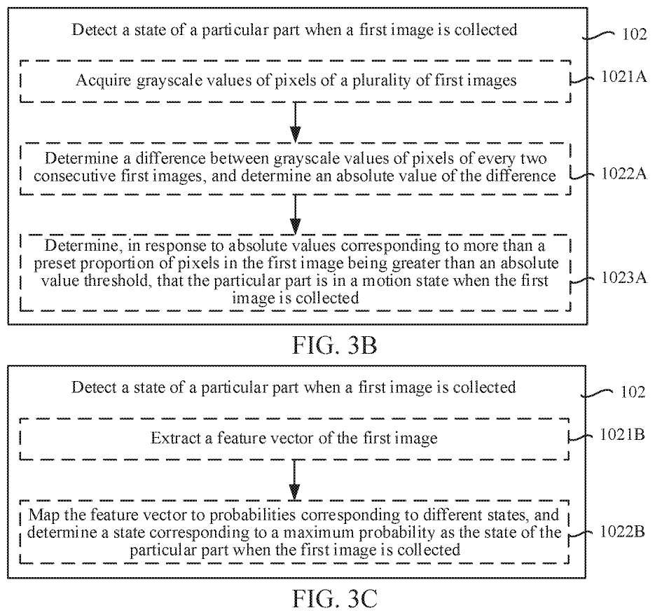

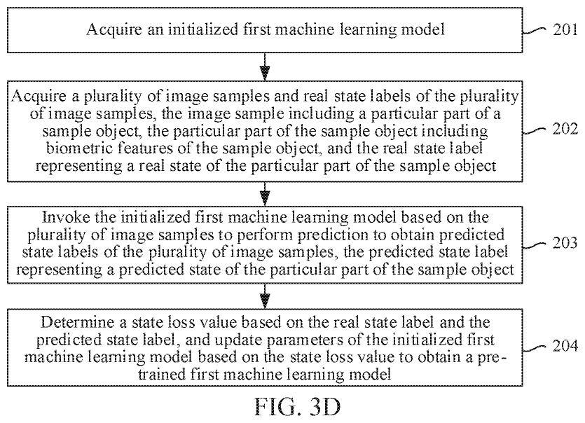

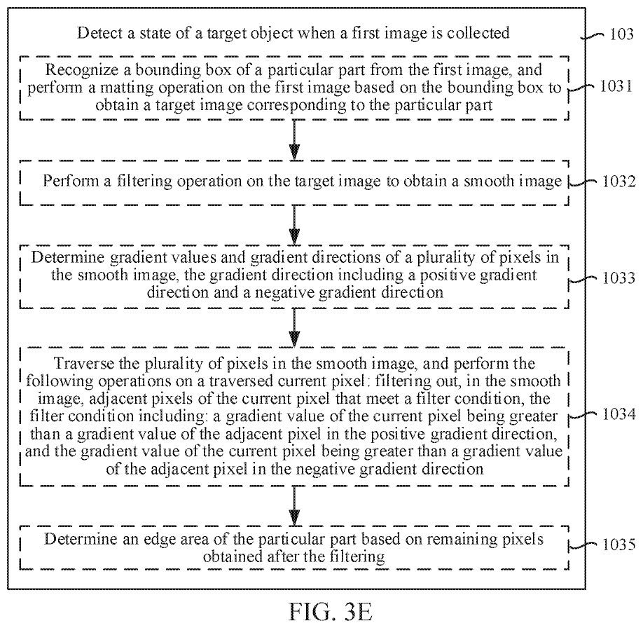

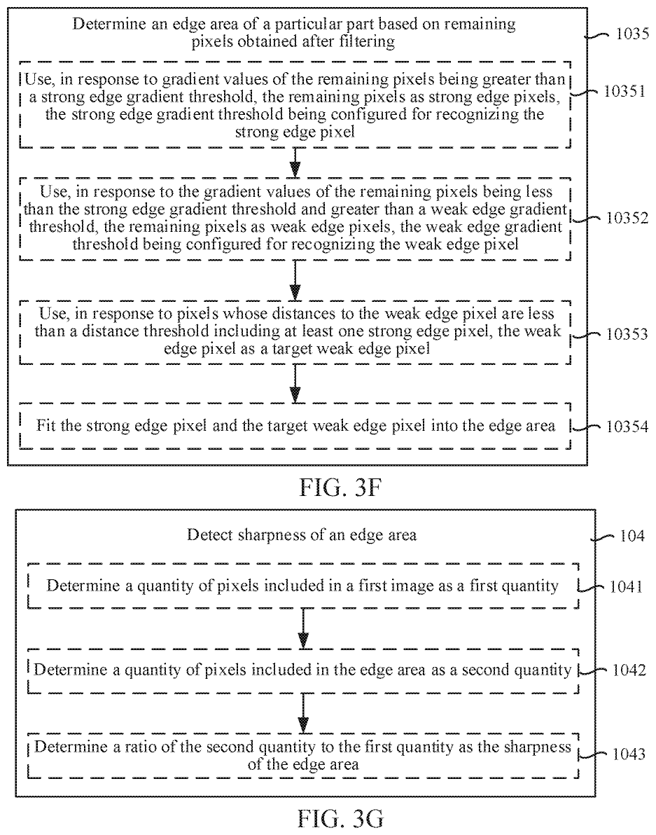

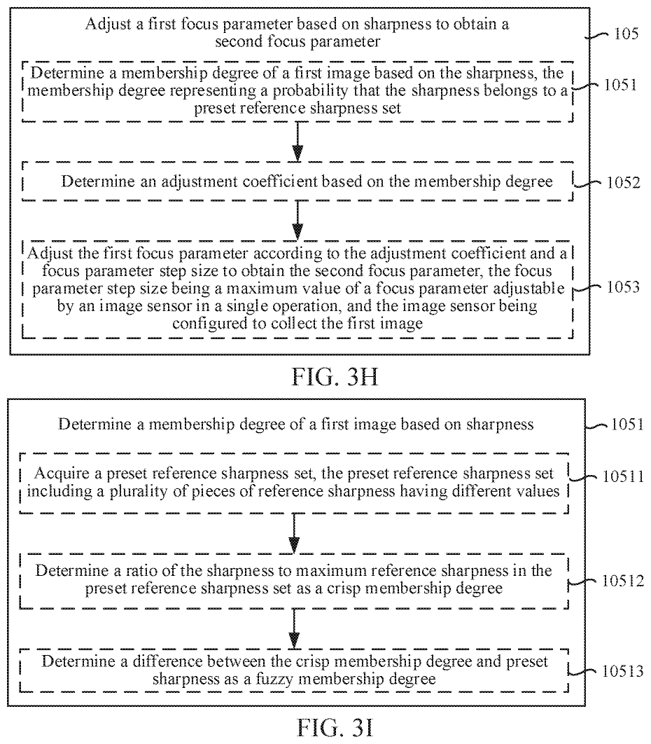

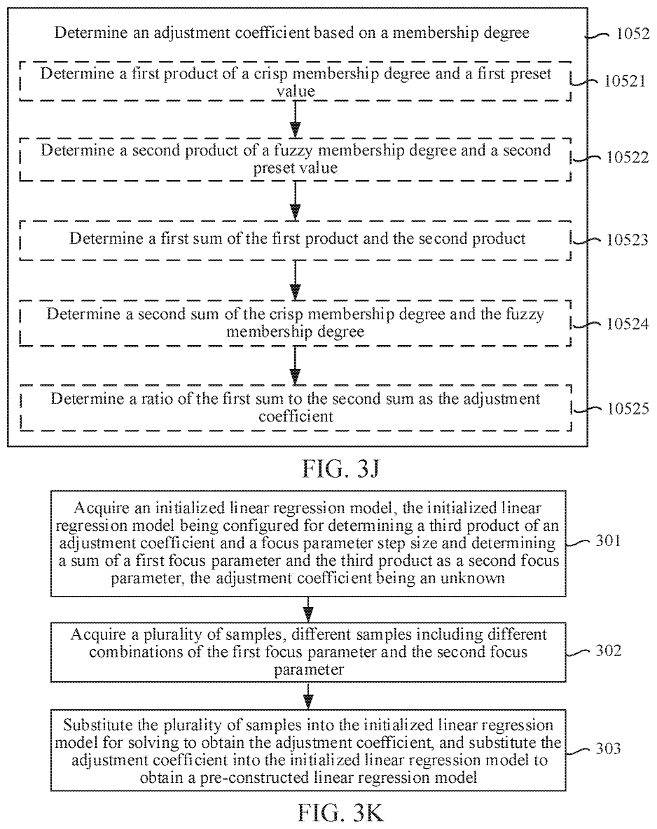

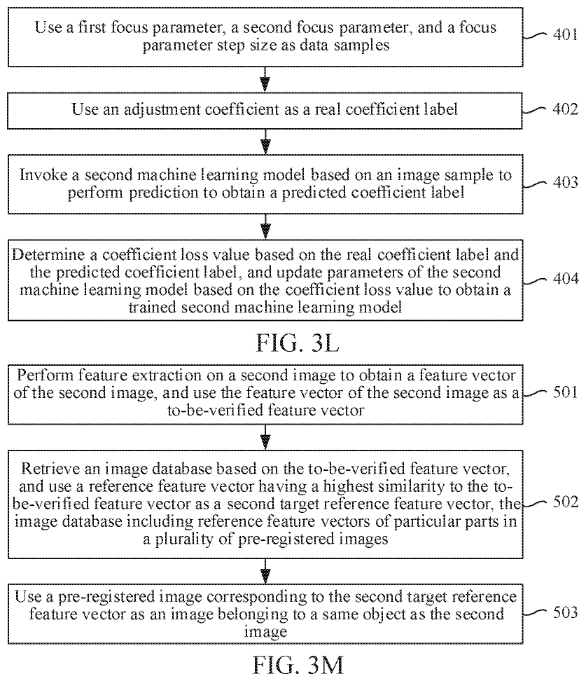

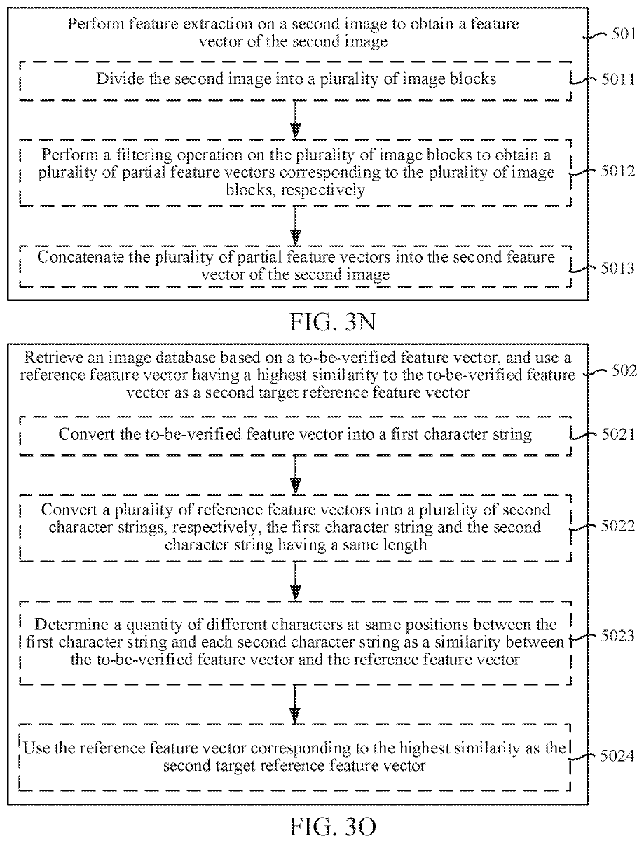

FIG. 3A is a first schematic flowchart of an image processing method according to an embodiment of the present disclosure. Using the server as a subject, a description is provided with reference to operations shown in FIG. 3A.

Operation 101: Acquire a first image including a particular part of a target object, the first image being collected based on a first focus parameter, and the particular part including biometric features of the target object.

In some embodiments, the first image is collected through an image sensor. The image sensor may be built into the electronic device, or may be externally connected to the electronic device. The particular part refers to a part including the biometric features of the target object in the image.

Exemplarily, the particular part may be any one of the following: a palm, a sole, a pupil, and a face. When the particular part is a palm or a sole, the biometric feature may be a palm print. When the particular part is a pupil, the biometric feature may be an iris. When the particular part is a face, the biometric feature may be the facial appearance. In addition to inherent physiological features of the human body, the biometric features further include behavior features, such as a gait.

Operation 102: Detect a state of the particular part when the first image is collected.

In some embodiments, the type of the state of the particular part includes a static state and a motion state.

An example in which the particular part is a pupil is used. It is assumed that the collected first image includes the pupil of the target object. When the user's eyes rotate left and right, the state of the pupil is a motion state when the first image is collected, causing the collected first image to be blurred. An example in which the particular part is a finger is used. It is assumed that the collected first image includes the finger of the target object. When the user swings the finger, the state of the finger is a motion state when the first image is collected, causing the collected first image to be blurred.

In some embodiments, when there are a plurality of first images and the plurality of first images are consecutive frames of images, for example, assuming that the image sensor collects images at a frame rate of 30 frames per second, that is, 30 frames of images can be collected in one second, the 30 frames of images collected in this second are referred to as consecutive frames of images. That is, the consecutive frames of images are a plurality of images that are sequentially collected by the image sensor according to a particular frame and are consecutive in collection order. FIG. 3B is a second schematic flowchart of an image processing method according to an embodiment of the present disclosure. For the foregoing case of consecutive frames of images, operation 102 in FIG. 3A may be implemented through operation 1021A to operation 1023A in FIG. 3B. Details are described below.

Operation 1021A: Acquire grayscale values of pixels of the plurality of first images.

In some embodiments, for each pixel in each first image, grayscale values of three color channels corresponding to the pixel in the first image are acquired, and then an average value of the grayscale values of the three color channels is calculated as the grayscale value of the pixel of the first image. A grayscale value (gray level) is a value representing brightness of a pixel in an image. During digital image processing, the grayscale value is an integer ranging from 0 to 255, where 0 represents black, 255 represents white, and intermediate values represent different degrees of gray. This representation method is used for grayscale conversion of a black-and-white image or a color image.

Exemplarily, the grayscale being 0-255 is used as an example. Assuming that grayscale values of three color channels corresponding to any pixel in any first image are 110, 120, and 160, respectively, a grayscale value of the pixel is (110+120+160)/3=130.

Operation 1022A: Determine a difference between grayscale values of pixels of every two consecutive first images, and determine an absolute value of the difference.

In some embodiments, a difference between grayscale values of pixels at a same position in any two consecutive first images is determined, and an absolute value of the difference is determined.

Exemplarily, grayscale values of pixels at the same position in two consecutive first images are determined. For example, according to a collection order, the plurality of first images are a first image A, a first image B, and a first image C, respectively. Any two successive first images are used as two consecutive first images. For example, the first image A and the first image B are two consecutive first images, and the first image B and the first image C are also two consecutive first images. Using the first image A and the first image B as an example, if grayscale values of pixels located in the third row and the fifth column in the first image A and the first image B are 100 and 180, respectively, a difference between the grayscale values is −80, and an absolute value of the difference is 80.

Operation 1023A: Determine, when absolute values corresponding to more than a preset proportion of pixels in the first image are greater than an absolute value threshold, that the particular part is in the motion state when the first image is collected.

Exemplarily, the preset proportion is 50%, and the absolute value threshold is 50. If absolute values corresponding to 80% of pixels in the first image exceed 50, it may be determined that the particular part is in the motion state when the first image is collected.

Exemplarily, a plurality of image samples are acquired, and the image samples are manually annotated according to the states of the particular parts in the image samples. For example, a label of an image sample in which the particular part is in the motion state is a “motion state”. Statistics collection is performed on a proportion between image samples in each state and all image samples, and an average value or an intermediate value of proportions corresponding to all states is used as the preset proportion.

In some embodiments, as an alternative solution of operation 1021A to operation 1023A, an optical flow method may further be adopted to detect the state of the particular part when the first image is collected. A velocity vector is assigned to each pixel in the first image, and the image is dynamically analyzed according to velocity vector features of the pixels. When the particular part is in the static state, the optical flow vector continuously changes in the entire first image area. When the particular part is in the motion state, there is relative motion between the particular part and the background of the first image, and a velocity vector formed by the particular part is different from a velocity vector of the background, thereby determining that the particular part is in the motion state when the first image is collected.

Exemplarily, two consecutively collected first images are acquired, which are a frame 1 and a frame 2, respectively. An optical flow vector between the frame 1 and the frame 2 is calculated using an optical flow method. It is assumed that in the frame 1, an average value of velocity vectors of pixels of the particular part is (0, 0), indicating that the particular part is in the static state. In the frame 2, the particular part of the target object starts to move, and the average value of the velocity vectors of the pixels of the particular part is updated to (2, 1), indicating that the particular part moves to the right by two pixels and moves down by one pixel, indicating that the particular part is in the motion state.

In this embodiment of the present disclosure, the state of the particular part in the first image is detected through the optical flow method, so that motion information in an image sequence may be calculated in real time, and pixel-level motion information can be provided, providing relatively high accuracy. The optical flow method exhibits particular robustness to illumination changes, blocking, and the like, enabling stable work in complex environments.

In some embodiments, when there is one first image, for example, when only an initial image is collected through the image sensor (that is, one first image is collected), the state of the particular part may be detected based on only one first image. FIG. 3C is a third schematic flowchart of an image processing method according to an embodiment of the present disclosure. Operation 102 in FIG. 3A may be implemented by invoking a pre-trained first machine learning model to perform operation 1021B to operation 1022B in FIG. 3C. Details are described below.

Operation 1021B: Extract a feature vector of the first image.

In some embodiments, a Transformer encoder, a convolutional neural network (CNN), a feature pyramid network (FPN), an attention model, a graph neural network (GNN), and a generative adversarial network may be adopted to perform feature extraction on the first image to obtain the feature vector of the first image. The CNN includes a visual geometry group net (VGGNet), a residual network (ResNet), and a lightweight deep neural network (MobileNet) for an embedded device such as a mobile phone.

Exemplarily, using the Transformer encoder as an example, for the first image, the first image is first segmented into image blocks of a fixed size. Then, the segmented image blocks are flattened into a sequence. The flattened sequence is a vector sequence of a fixed length, and each vector in the vector sequence represents an image block. Secondly, an embedding layer is applied to each element of the sequence to introduce position information and other context information. For an image block, the embedding layer may include position embedding and linear embedding. Finally, the embedded sequence is processed using the Transformer encoder, a weight is assigned to each element in the embedded sequence using a multi-head attention mechanism, and weighted summation is performed to obtain a new sequence representation. Then, the new sequence representation is mapped to a high-dimensional space through a fully-connected layer and an intermediate layer in a feedforward neural network to capture complex relationships between elements in the sequence, thereby finally obtaining the feature vector of the first image.

Operation 1022B: Map the feature vector to probabilities corresponding to different states, and determine a state corresponding to a maximum probability as the state of the particular part when the first image is collected.

In some embodiments, probabilities that the feature vector corresponds to different states are determined through a classifier. The different states include a plurality of candidate states of the particular part, for example, may include the static state and the motion state. A state having a maximum probability value between the probability of the static state and the probability of the motion state is selected as the state of the particular part when the first image is collected.

Exemplarily, assuming that a probability that the feature vector is mapped to the static state is 30%, and a probability that the feature vector is mapped to the motion state is 70%, the state of the particular part is the motion state when the first image is collected.

In some embodiments, before the pre-trained first machine learning model is invoked, reference is made to FIG. 3D. FIG. 3D is a fourth schematic flowchart of an image processing method according to an embodiment of the present disclosure. The pre-trained first machine learning model may be constructed through operation 201 to operation 204 in FIG. 3D. Details are described below.

Operation 201: Acquire an initialized first machine learning model.

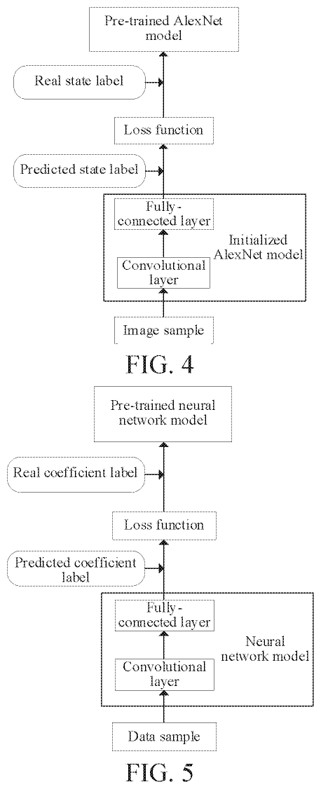

Exemplarily, the first machine learning model may be an AlexNet model. FIG. 4 is a schematic structural diagram of an AlexNet model according to an embodiment of the present disclosure. In FIG. 4, the AlexNet model may include a convolutional layer and a fully-connected layer. Initialization represents randomly assigning values to parameters of the model, for example, assigning all the parameters of the model to 0 or assigning all the parameters to 1.

Operation 202: Acquire a plurality of image samples and real state labels of the plurality of image samples, the image sample including a particular part of a sample object, the particular part of the sample object including biometric features of the sample object, and the real state label representing a real state of the particular part of the sample object.

In some embodiments, if the real state of the particular part of the sample object included in the image sample is the motion state, the motion state is used as the real state label of the image sample. The states of the particular parts included in different image samples may be different.

Exemplarily, the real state label of the image sample includes the motion state and the static state. For example, the real state label may be acquired by manual annotation.

Operation 203: Invoke the initialized first machine learning model based on the plurality of image samples to perform prediction to obtain predicted state labels of the plurality of image samples, the predicted state label representing a predicted state of the particular part of the sample object.

In some embodiments, the predicted state label includes the static state and the motion state.

Exemplarily, referring to FIG. 4, an example in which the first machine learning model is an AlexNet model is used. An image sample is inputted into an initialized AlexNet model, and a convolution operation is performed through a convolutional layer in the initialized AlexNet model to obtain a feature vector of the image sample. Then, the feature vector of the image sample is inputted into a fully-connected layer, and then a predicted state label is obtained through the fully-connected layer.

Operation 204: Determine a state loss value based on the real state label and the predicted state label, and update parameters of the initialized first machine learning model based on the state loss value to obtain the pre-trained first machine learning model.

In some embodiments, the state loss value between the real state label and the predicted state label is determined through a loss function, and back propagation is performed on the state loss value to update the parameters of the initialized first machine learning model. The process of calculating the state loss value and updating the parameters is iteratively performed a plurality of times, until the state loss value no longer increases or decreases. The iterative process is stopped, to form the pre-trained first machine learning model.

As an example, the loss function may be a mean square error loss function, a cross entropy loss function, a multi-label classification loss function, and a triplet loss function.

As an example, the back propagation is implemented through a back propagation algorithm. A gradient of each neuron is calculated from an output layer to an input layer, a weight and a bias of the neuron are updated according to the gradient, and the parameters are continuously updated through gradient descent, so that the loss value is reduced. The gradient descent may adopt various gradient descent algorithms, such as a batch gradient descent algorithm, a stochastic gradient descent algorithm, an adaptive gradient descent algorithm, and a momentum gradient descent algorithm.

In this embodiment of the present disclosure, probabilities that the feature vector corresponds to different states are determined through the pre-trained first machine learning model. In an automated process, a large amount of image data may be rapidly processed without manual analysis, thereby improving the working efficiency. The pre-trained first machine learning model is usually trained on a large amount of data, and can learn rich feature representations, thereby improving the accuracy of state recognition. Determination standards of the models are consistent, thereby avoiding subjectivity and inconsistency that may be brought by human determination.

In some embodiments, when the absolute values corresponding to more than the preset proportion of pixels in the first image being greater than the absolute value threshold, it is determined that the target object is in the static state when the first image is collected. Feature extraction is performed on the first image to obtain the feature vector of the first image. An image database is retrieved based on the feature vector of the first image, and a reference feature vector having a highest similarity to the feature vector of the first image is used as a first target reference feature vector. The image database includes reference feature vectors of particular parts in a plurality of pre-registered images. A pre-registered image corresponding to the first target reference feature vector is used as an image belonging to a same object as the first image.

As an example, feature extraction may be performed on the first image through a grayscale co-occurrence matrix. Specifically, grayscale processing is performed on the first image to obtain a first grayscale image. A grayscale value difference between each pixel pair (any two adjacent pixels) in the first grayscale image is calculated according to a preset distance and a direction parameter. The distance is usually a positive integer, and represents the distance between the pixels. The direction may be 0 degrees, 45 degrees, 90 degrees, or 135 degrees, and represents a relative direction between the pixels. Statistics collection is performed on a quantity of occurrences of each grayscale value difference, and a plurality of occurrences are arranged according to an order of the grayscale values to obtain a co-occurrence matrix. A row of the co-occurrence matrix represents a grayscale value of a first pixel in a pixel pair, a column represents a grayscale value of a second pixel in the pixel pair, and an element in the co-occurrence matrix represents a quantity of occurrences of a pixel pair having a particular grayscale value difference. For example, if a grayscale value of a first pixel of a pixel pair is 50, and a grayscale value of a second pixel is 60, element values of elements in the 51st row (since the grayscale value starts from 0) and the 61st column of the co-occurrence matrix are added by 1. A plurality of texture features of the first image are extracted from the co-occurrence matrix, such as contrast, average value, variance, and entropy. The texture features are configured for describing texture characteristics of the first image, such as coarseness, directionality, and regularity. The plurality of texture features are concatenated to form the feature vector of the first image. The similarity between the feature vector of the first image and the reference feature vector may be calculated through the cosine similarity. Specifically, a cosine value of an included angle between the feature vector of the first image and the reference feature vector is calculated as the similarity. A larger cosine value of the included angle indicates a higher similarity.

Operation 103: Perform, when the state of the particular part being a motion state, edge detection on the particular part in the first image to obtain an edge area of the particular part.

In some embodiments, FIG. 3E is a fifth schematic flowchart of an image processing method according to an embodiment of the present disclosure. Operation 103, i.e., “performing edge detection on the particular part in the first image to obtain an edge area of the particular part”, in FIG. 3A may be implemented through operation 1031 to operation 1035 in FIG. 3E. Details are described below.

Operation 1031: Recognize a bounding box of the particular part from the first image, and perform a matting operation on the first image based on the bounding box to obtain a target image corresponding to the particular part.

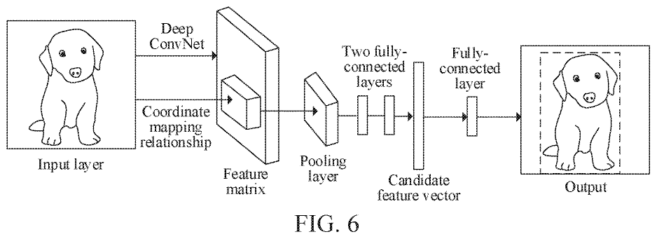

In some embodiments, the bounding box of the particular part may be recognized from the first image using a target recognition algorithm, such as a support vector machine-based target recognition algorithm, a Naive Bayes-based target recognition algorithm, and a neural network-based target recognition algorithm. FIG. 6 is a schematic diagram of a principle of a target recognition algorithm according to an embodiment of the present disclosure. A first image is input into a deep ConvNet to obtain a feature map of the image, and feature mapping is performed according to a coordinate mapping relationship between a candidate area and an entire image to obtain a feature matrix of each candidate area. Each feature matrix is pooled to a fixed size through a pooling layer and then flattened into a vector. Then, the vector passes through two fully-connected layers to obtain a candidate feature vector. Finally, the feature vector passes through a fully-connected layer to obtain a position of the bounding box of the target object. A matting operation is performed on the first image based on the bounding box to obtain the target image corresponding to the particular part.

Operation 1032: Perform a filtering operation on the target image to obtain a smooth image.

In some embodiments, a filtering operation is performed on the target image through a Gaussian filter. For example, convolution is performed on the target image to obtain a smooth image.

Exemplarily, performing a filtering operation on the target image through the Gaussian filter is as follows. A size of a Gaussian kernel is first determined. The size of the Gaussian kernel refers to a size of a kernel matrix used when Gaussian filtering is performed, and is represented by an odd number, such as 3×3, 5×5, or 7×7. The size of the Gaussian kernel determines a filtering range, that is, how many adjacent pixels each pixel refers to in a filtering process. The size of the Gaussian kernel may be manually set. Then, a convolution operation is performed on the Gaussian kernel and the target image. For each pixel in the target image, the following processing is performed: aligning a center of the Gaussian kernel to a current pixel, and determining a product of a weight value at any position in the Gaussian kernel and a grayscale value of a pixel corresponding to the position; determining a sum of all products in an area where the Gaussian kernel is located, determining a ratio of the sum to a quantity of pixels in the area where the Gaussian kernel is located, as a weighted average value of the current pixel, and replacing the grayscale value of the current pixel with the weighted average value to obtain the smooth image.

Operation 1033: Determine gradient values and gradient directions of a plurality of pixels in the smooth image, the gradient direction including a positive gradient direction and a negative gradient direction.

In some embodiments, four operators are adopted to detect horizontal, vertical, and diagonal edges in an image. The edge detection operators, such as a Roberts operator, a Prewitt operator, and a Sobel operator, return first-order derivative values of the smooth image in a horizontal direction and a vertical direction. A sum of a square of the first-order derivative value of the smooth image in the horizontal direction and a square of the first-order derivative value of the smooth image in the vertical direction is calculated, and a square root of the sum is calculated to obtain a gradient value of a pixel. A ratio of the first-order derivative value of the smooth image in the vertical direction to the first-order derivative value of the smooth image in the horizontal direction is calculated and then substituted into an arctangent function to obtain a gradient direction of the pixel.

Exemplarily, if the first-order derivative value of the smooth image in the horizontal direction is a, and the first-order derivative value of the smooth image in the vertical direction is b, the square of the first-order derivative value of the smooth image in the horizontal direction is a², the square of the first-order derivative value of the smooth image in the vertical direction is b², and the sum is a²+b². A square root of the sum is √(a²+b²), that is, the gradient value of the pixel is √(a²+b²). The ratio of the first-order derivative value b of the smooth image in the vertical direction to the first-order derivative value a of the smooth image in the horizontal direction is b/a. The ratio is substituted into an arctangent function arctan( ) to obtain that the gradient direction of the pixel is arctan(b/a).

Operation 1034: Traverse the plurality of pixels in the smooth image, and perform the following operations on a traversed current pixel: filtering out, in the smooth image, adjacent pixels of the current pixel that meet a filter condition, the filter condition including: a gradient value of the current pixel being greater than a gradient value of the adjacent pixel in the positive gradient direction, and the gradient value of the current pixel being greater than a gradient value of the adjacent pixel in the negative gradient direction.

In some embodiments, the gradient value of the current pixel is compared with pixel values of pixels in the positive gradient direction and the negative gradient direction. If the gradient value of the current pixel is greater than the gradient value of the pixel in the positive gradient direction and greater than the gradient value of the pixel in the negative gradient direction, the current pixel is reserved. If the gradient value of the current pixel is less than the gradient value of the pixel in the positive gradient direction and less than the gradient value of the pixel in the negative gradient direction, the current pixel is filtered out.

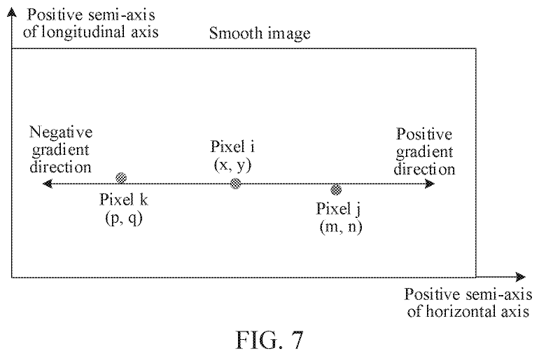

As an example, FIG. 7 is a schematic diagram of a positive gradient direction and a negative gradient direction of a current pixel according to an embodiment of the present disclosure. In FIG. 7, an endpoint at a lower left corner of the smooth image is used as an origin of the coordinate system, and a lower edge of the smooth image is used as a positive semi-axis of a horizontal axis of the coordinate system. If a position of a current pixel i in the coordinate system is (x, y), the gradient value is 5, and the positive gradient direction of the pixel i is the same as the positive semi-axis direction. It is assumed that coordinates of a pixel j in the positive gradient direction of the current pixel i are (m, n), where m>x, and the gradient value of the pixel j is 3; and coordinates of a pixel k in the negative gradient direction of the current pixel i are (p, q), where p<x, and the gradient value of the pixel k is 1. Thus, the current pixel i is reserved. Assuming that the gradient value of the pixel j is 7, and the gradient value of the pixel k is 9, the pixel i is filtered out.

Operation 1035: Determine the edge area of the particular part based on remaining pixels obtained after the filtering.

In some embodiments, the remaining pixels obtained after the filtering are fitted, and a curve formed by fitting is used as the edge area of the particular part.

In this embodiment of the present disclosure, the bounding box of the particular part is recognized, and a matting operation is performed, so that the particular part may be precisely positioned, thereby avoiding interference from background noise and improving the accuracy of edge detection. Filtering and gradient calculation are performed on the target image, thereby reducing unnecessary calculation and improving the processing efficiency. The filtering operation may smooth an image, reduce noise, and enhance edge information, so that gradient calculation is more accurate. By analyzing the gradient value and the gradient direction and applying the filter condition, an edge may be effectively refined, and a false edge may be removed, thereby obtaining a sharp and coherent edge area.

In some embodiments, FIG. 3F is a sixth schematic flowchart of an image processing method according to an embodiment of the present disclosure. Operation 1035 in FIG. 3E may be implemented through operation 10351 to operation 10354 in FIG. 3E. Details are described below.

Operation 10351: Use, when gradient values of the remaining pixels are greater than a strong edge gradient threshold, the remaining pixels as strong edge pixels, the strong edge gradient threshold being configured to recognize the strong edge pixel.

In some embodiments, the strong edge gradient threshold is preset. The strong edge gradient threshold may be determined using an automatic threshold selection algorithm, such as an Otsu method, K-means clustering, and an entropy method. A histogram of the first image is acquired. Based on grayscale distribution in the histogram of the first image, a threshold separating a foreground and a background is determined as the strong edge gradient threshold.

Exemplarily, if the strong edge gradient threshold is 10, and the gradient value of the remaining pixel is 20, the remaining pixel is used as the strong edge pixel.

Operation 10352: Use, when the gradient values of the remaining pixels are less than the strong edge gradient threshold and greater than a weak edge gradient threshold, the remaining pixels as weak edge pixels, the weak edge gradient threshold being configured to recognize the weak edge pixel.

In some embodiments, the weak edge gradient threshold is preset. The weak edge gradient threshold may be determined through a proportion method, an empirical rule, an automatic threshold selection algorithm, an adaptive threshold, or cross validation. Using the proportion method as an example, a proportionality coefficient is selected. The proportionality coefficient ranges from 0 to 1. A product of the proportionality coefficient and the strong edge gradient threshold is determined and used as the weak edge gradient threshold. Using the adaptive threshold as an example, the first image is divided into a plurality of windows. For each window, local statistics of the window are calculated. The local statistics include an average gradient and a standard deviation. A product of a constant and the standard deviation is determined, and a sum of the product and the average gradient is determined and used as the weak edge gradient threshold. The constant is configured to control a position of the weak edge gradient threshold relative to the average value and the standard deviation.

Exemplarily, if the strong edge gradient threshold is 10, the weak edge gradient threshold is 8, and the gradient value of the remaining pixel is 9, the remaining pixel is used as the weak edge pixel.

In some embodiments, when the gradient of the remaining pixel is less than the weak edge gradient threshold, the remaining pixel is deleted.

Exemplarily, the weak edge gradient threshold is preset. If the weak edge gradient threshold is 8, and the gradient value of the remaining pixel is 5, the remaining pixel is deleted.

Operation 10353: Use, when pixels whose distances to the weak edge pixel are less than a distance threshold including at least one strong edge pixel, the weak edge pixel as a target weak edge pixel.

In some embodiments, when a preset quantity of pixels whose distances to the weak edge pixel are less than the distance threshold including at least one strong edge pixel, the weak edge pixel is used as the target weak edge pixel. Different preset quantities may be tried. A preset quantity that can reduce noise impact while maintaining edge continuity is selected according to an edge detection result.

Exemplarily, the distance threshold is 10, and the preset quantity is 5. If at least one of 5 pixels whose distances to the weak edge pixel are less than 10 is a strong edge pixel, the weak edge pixel is used as the target weak edge pixel.

Operation 10354: Fit the strong edge pixel and the target weak edge pixel into the edge area.

In some embodiments, the strong edge pixel and the target weak edge pixel are fitted, and a curve formed by fitting is used as the edge area.

Exemplarily, fitting may be performed using a least square method. Assuming that a sum of quantities of strong edge pixels and target weak edge pixels is m, any strong edge pixel or the target weak edge pixel is represented as, where =1, 2, . . . ,. An approximate curve determined by the strong edge pixel and the target weak edge pixel is solved. A deviation of the approximate curve at a point is calculated, =1, 2, . . . , and an approximate curve with a smallest deviation is used as the edge area.

In this embodiment of the present disclosure, the strong edge gradient threshold and the weak edge gradient threshold are set, so that an edge in an image may be recognized more accurately. The strong edge gradient threshold is configured to recognize a significant edge, and the weak edge gradient threshold is configured to recognize a less significant edge, thereby improving comprehensiveness and accuracy of edge detection. By determining whether strong edge pixels exist around a weak edge pixel, the weak edge pixel may be effectively distinguished from noise, thereby avoiding mistaking the noise for an edge. Fitting the strong edge pixel and the target weak edge pixel into the edge area helps maintain continuity of the edge.

Operation 104: Detect sharpness of the edge area.

In some embodiments, FIG. 3G is a seventh schematic flowchart of an image processing method according to an embodiment of the present disclosure. Operation 104 in FIG. 3A may be implemented through operation 1041 to operation 1043 in FIG. 3G. Details are described below.

Operation 1041: Determine a quantity of pixels included in the first image as a first quantity.

In some embodiments, a size of the first image is acquired. The size of the image is expressed in pixels, and the size of the first image includes a width and a height. A product of the width and the height is determined and used as the quantity of pixels included in the first image. If the first image includes color channels, a product of the width, the height, and a quantity of color channels is determined as the quantity of pixels included in the first image.

Exemplarily, if the width of the first image is 400 pixels, and the height is 800 pixels, the product of the width and the height is 40×80=3,200, that is, the quantity of pixels included in the first image is 3,200. If the first image is a red, green, and blue (RGB) image, the quantity of color channels of the first image is 3, and the product of the width, the height, and the quantity of color channels is 40×80 ×3=9,600, that is, the quantity of pixels included in the first image is 9,600.

Operation 1042: Determine a quantity of pixels included in the edge area as a second quantity.

In some embodiments, statistics collection is performed on a quantity of strong edge pixels and a quantity of target weak edge pixels included in the edge area, and a sum of the quantity of strong edge pixels and the quantity of target weak edge pixels is determined and used as the quantity of pixels included in the edge area, that is, the second quantity.

Exemplarily, if the edge area includes 600 strong edge pixels and 1,000 target weak edge pixels, and the sum of the quantity of strong edge pixels and the quantity of target weak edge pixels is 1,600, the quantity of pixels included in the edge area is 1,600, and 1,600 is used as the second quantity.

Operation 1043: Determine a ratio of the second quantity to the first quantity as the sharpness of the edge area.

Following the examples of operation 1041 and operation 1042, the first quantity is 9,600, and the second quantity is 1,600. Thus, the sharpness of the edge area is 1,600/9,600=⅙.

In this embodiment of the present disclosure, a ratio of the quantity of pixels in the edge area to a quantity of pixels in the entire image is calculated, so that the sharpness of the edge may be quantified, providing an objective index for evaluation of image quality. The calculation process is simple, thereby improving calculation efficiency and simplicity.

Operation 105: Adjust the first focus parameter based on the sharpness to obtain a second focus parameter, the second focus parameter being configured to replace the first focus parameter to collect a second image including the particular part of the target object.

In some embodiments, FIG. 3H is an eighth schematic flowchart of an image processing method according to an embodiment of the present disclosure. Operation 105, i.e., “adjusting the first focus parameter based on the sharpness to obtain a second focus parameter”, in FIG. 3A may be implemented through operation 1051 to operation 1053 in FIG. 3H. Details are described below.

Operation 1051: Determine a membership degree of the first image based on the sharpness, the membership degree representing a probability that the sharpness belongs to a preset reference sharpness set.

In some embodiments, the membership degree includes a crisp membership degree and a fuzzy membership degree. The crisp membership degree represents a probability that the sharpness belongs to the preset reference sharpness set in a crisp dimension, and the fuzzy membership degree represents a probability that the sharpness belongs to the preset reference sharpness set in a fuzzy dimension. FIG. 3I is a ninth schematic flowchart of an image processing method according to an embodiment of the present disclosure. Operation 1051, i.e., “determining a membership degree of the first image based on the sharpness”, in FIG. 3H may be implemented through operation 10511 to operation 10513 in FIG. 3I. Details are described below.

Operation 10511: Acquire the preset reference sharpness set, the preset reference sharpness set including a plurality of pieces of reference sharpness having different values.

In some embodiments, a standard of the sharpness is first defined. Standards of edge sharpness expected in different scenes are different. For example, different types of images such as scenery photos, portrait photos, and document scans have different sharpness standards. A group of representative sample images is collected. These sample images cover different types of scenes and sharpness levels. Edge detection is performed on the sample images, and edge sharpness of each image is calculated. Based on the edge sharpness of the sample images, a plurality of pieces of reference sharpness having different values are determined. The plurality of pieces of reference sharpness cover different sharpness levels from very blurry to very sharp. The plurality of pieces of reference sharpness having different values are combined into the preset reference sharpness set.

Exemplarily, the reference sharpness in the preset reference sharpness set may range from 0 to 100.

Operation 10512: Determine a ratio of the sharpness to maximum reference sharpness in the preset reference sharpness set as the crisp membership degree.

Following the example of operation 10511, the reference sharpness in the preset reference sharpness set ranges from 0 to 100, where the maximum reference sharpness is 100. If the sharpness is 60, the crisp membership degree is 60/100=0.6.

Operation 10513: Determine a difference between the crisp membership degree and preset sharpness as the fuzzy membership degree.

Following the example of operation 10512, the preset sharpness is 1, and the crisp membership degree is 0.6. Thus, the fuzzy membership degree is 1−0.6=0.4.

In this embodiment of the present disclosure, image sharpness may be multi-dimensionally evaluated through the crisp membership degree and the fuzzy membership degree. The membership degree describes a degree that the sharpness belongs to a reference sharpness set in the form of a probability, providing a quantitative and standardized evaluation manner for image quality evaluation. The preset reference sharpness set may be adjusted according to different application requirements, thereby improving flexibility and applicability of evaluation.

Operation 1052: Determine an adjustment coefficient based on the membership degree.

In some embodiments, FIG. 3J is a tenth schematic flowchart of an image processing method according to an embodiment of the present disclosure. Operation 1052 in FIG. 3H may be implemented through operation 10521 to operation 10525 in FIG. 3J. Details are described below.

Operation 10521: Determine a first product of the crisp membership degree and a first preset value.

Exemplarily, if the crisp membership degree is 0.6, and the first preset value is 0, the first product is 0.

Operation 10522: Determine a second product of the fuzzy membership degree and a second preset value.

Exemplarily, if the fuzzy membership degree is 0.4, and the second preset value is 1, the second product is 0.4.

Herein, settings of the first preset value and the second preset value are usually obtained based on experience and experimental data. For example, if the sharpness is more important than blurriness in an application scene, the first preset value may be set to be greater than the second preset value, to emphasize the impact of the sharpness. Otherwise, if the blurriness is more important, the second preset value may be set to be greater than the first preset value.

Operation 10523: Determine a first sum of the first product and the second product.

Exemplarily, if the first product is 0, and the second product is 0.4, the first sum is 0.4.

Operation 10524: Determine a second sum of the crisp membership degree and the fuzzy membership degree.

Exemplarily, if the crisp membership degree is 0.6, and the fuzzy membership degree is 0.4, the second sum is 1.

Operation 10525: Determine a ratio of the first sum to the second sum as the adjustment coefficient.

Exemplarily, if the first sum is 0.4, and the second sum is 1, the adjustment coefficient is 0.4.

In this embodiment of the present disclosure, by setting the first preset value and the second preset value, different weights may be assigned to the crisp membership degree and the fuzzy membership degree, thereby emphasizing or attenuating impact of a particular dimension during calculation of the adjustment coefficient. The preset value may be adjusted according to a specific application scene and requirement, so that the adjustment coefficient can better reflect an actual situation of image quality. The adjustment coefficient comprehensively considers the crisp membership degree and the fuzzy membership degree, providing a comprehensive image quality evaluation index.

Operation 1053: Adjust the first focus parameter according to the adjustment coefficient and a focus parameter step size to obtain the second focus parameter, the focus parameter step size being a maximum value of a focus parameter adjustable by an image sensor in a single operation, and the image sensor being configured to collect the first image.

In some embodiments, as an alternative solution of operation 1051 to operation 1053, a non-depth image of the particular part in the first image may be acquired using a zoom camera. A focus area requiring focusing in the non-depth image is acquired. A depth image of the particular part in the first image is acquired using a depth camera. The depth camera is registered with the zoom camera to acquire depth values of pixels in the focus area of the non-depth image. Depth information of the area is calculated according to the depth values of the pixels in the focus area, a focal length of the lens of the zoom camera is adjusted according to the depth information, and a second image is collected based on the adjusted focal length.

In some embodiments, as an alternative solution of operation 1051 to operation 1053, environmental parameters such as light, air quality, and humidity may further be acquired according to external environmental changes. The environmental parameters are inputted into a preset mathematical model to calculate an appropriate focal length. A physical distance between the lens and the image sensor is changed according to the focal length, thereby capturing a sharp second image.

In some embodiments, a pre-constructed parameter control model is invoked according to the adjustment coefficient and the focus parameter step size to adjust the first focus parameter to obtain the second focus parameter.

In some embodiments, when the parameter control model is a linear regression model, reference is made to FIG. 3K. FIG. 3K is an eleventh schematic flowchart of an image processing method according to an embodiment of the present disclosure. Before the pre-constructed parameter control model is invoked, operation 301 to operation 303 in FIG. 3K may be used for implementation. Details are described below.

Operation 301: Acquire an initialized linear regression model, the initialized linear regression model being configured to determine a third product of the adjustment coefficient and the focus parameter step size and determining a sum of the first focus parameter and the third product as the second focus parameter, the adjustment coefficient being an unknown.

In some embodiments, the linear regression model may be: Second Focus Parameter=First Focus Parameter+Adjustment Coefficient*Focus Parameter Step Size, where the adjustment coefficient is an unknown.

Exemplarily, the second focus parameter is A, the first focus parameter is B, the focus parameter step size is C, and the adjustment coefficient is x, where A, B, and C are all constants, and x is an unknown. Then, the linear regression model may be represented as: A=B+x*C.

Operation 302: Acquire a plurality of samples, different samples including different combinations of the first focus parameter and the second focus parameter.

In some embodiments, combinations of the first focus parameter and the second focus parameter included in different samples are different.

Exemplarily, the first focus parameter included in the sample may be a focus parameter used when image collection is performed on the sample object. When image collection is performed on the sample object using the first focus parameter, the sample object may be in a static state or a motion state. The second focus parameter may be a focus parameter obtained after the first focus parameter is adjusted. When image collection is performed on the sample object using the second focus parameter, the sharpness of the particular part of the sample object in the collected image is greater than a sharpness threshold.

Operation 303: Substitute the plurality of samples into the initialized linear regression model for solving to obtain the adjustment coefficient, and substitute the adjustment coefficient into the initialized linear regression model to obtain a pre-constructed linear regression model.

In some embodiments, the focus parameter step size is a constant. When a plurality of samples, i.e., a plurality of combinations of the first focus parameter and the second focus parameter, are substituted, an unknown, i.e., an adjustment coefficient, may be solved. Then, the obtained adjustment coefficient is substituted into the initialized linear regression model to obtain the pre-constructed linear regression model.

Exemplarily, the initialized linear regression model is: A=B+x*C, where A is the second focus parameter, B is the first focus parameter, x is the adjustment coefficient, and C is the focus parameter step size. If the adjustment coefficient x is solved as 0.4, the pre-constructed linear regression model is: A=B+0.4*C.

In some embodiments, when the parameter control model is a pre-trained second machine learning model, reference is made to FIG. 3L. FIG. 3L is a twelfth schematic flowchart of an image processing method according to an embodiment of the present disclosure. Before the pre-constructed parameter control model is invoked, operation 401 to operation 404 in FIG. 3L may be used for implementation. Details are described below.

Operation 401: Use the first focus parameter, the second focus parameter, and the focus parameter step size as data samples.

Exemplarily, a format of the data sample may be <first focus parameter, second focus parameter, and a focus parameter step size>.

Operation 402: Use the adjustment coefficient as a real coefficient label.

Herein, the real coefficient label represents a real adjustment coefficient corresponding to the current first focus parameter, second focus parameter, and focus parameter step size.

Operation 403: Invoke the second machine learning model based on the image sample to perform prediction to obtain a predicted coefficient label.

In some embodiments, the image sample may be predicted through a fully-connected layer of the second machine learning model to obtain the predicted coefficient label. The predicted coefficient label represents an adjustment coefficient obtained through prediction according to the first focus parameter, the second focus parameter, and the focus parameter step size.

Exemplarily, the second machine learning model may be a neural network model. FIG. 5 is a schematic structural diagram of a neural network model according to an embodiment of the present disclosure. The data sample is inputted into the neural network model, and a convolution operation is performed through a convolutional layer in the neural network model to obtain a feature vector of the data sample. Then, the feature vector of the data sample is inputted into a fully-connected layer, and a predicted coefficient label is obtained through the fully-connected layer.

Operation 404: Determine a coefficient loss value based on the real coefficient label and the predicted coefficient label, and update parameters of the second machine learning model based on the coefficient loss value to obtain a trained second machine learning model.

In some embodiments, the coefficient loss value between the real coefficient label and the predicted coefficient label is determined through a loss function, and back propagation is performed on the coefficient loss value to update the parameters of the second machine learning model. The process of calculating the coefficient loss value and updating the parameters is iteratively performed a plurality of times, until the coefficient loss value no longer increases or decreases. The iterative process is stopped, to form the trained second machine learning model.

Exemplarily, the loss function includes a mean square error loss function, a cross entropy loss function, a multi-label classification loss function, and a triplet loss function. The back propagation is implemented through a back propagation algorithm. A gradient of each neuron is calculated from an output layer to an input layer, a weight and a bias of the neuron are updated according to the gradient, and the parameters are continuously updated through gradient descent, so that the loss value is reduced. The gradient descent may adopt various gradient descent algorithms, such as a batch gradient descent algorithm, a stochastic gradient descent algorithm, an adaptive gradient descent algorithm, and a momentum gradient descent algorithm.

In this embodiment of the present disclosure, the state of the particular part in the first image is detected. If the particular part is in the motion state when the first image is collected, the sharpness of the particular part including the biometric features is positioned by edge detection, and the first focus parameter used when the first image is adopted is adjusted according to the sharpness to obtain the second focus parameter, so as to collect the second image through the second focus parameter, thereby timely and adaptively adjusting a focus parameter collected next time according to the particular part in a previous image and according to the state of the particular part when the previous image is collected. The entire process requires no manual intervention, ensuring that a sharp image may be collected when the particular part is moving, and improving the sharpness of image collection.

In some embodiments, FIG. 3M is a thirteenth schematic flowchart of an image processing method according to an embodiment of the present disclosure. After the second image including the particular part of the target object is collected, operation 501 to operation 503 in FIG. 3M are performed. Details are described below.

Operation 501: Perform feature extraction on the second image to obtain a feature vector of the second image, and use the feature vector of the second image as a to-be-verified feature vector.

In some embodiments, FIG. 3N is a fourteenth schematic flowchart of an image processing method according to an embodiment of the present disclosure. Operation 501, i.e., “performing feature extraction on the second image to obtain a feature vector of the second image”, in FIG. 3M may be implemented through operation 5011 to operation 5013 in FIG. 3N. Details are described below.

Operation 5011: Divide the second image into a plurality of image blocks.

In some embodiments, the width of the second image is equally divided to obtain sub-widths. The height of the second image is equally divided to obtain sub-heights. The size of each image block is a product of the sub-width and the sub-height, and the sizes of the plurality of image blocks are the same.

Exemplarily, the size of the second image is 900*900 pixels. The second image is equally divided into 9 parts. That is, the width of the second image is equally divided into 3 parts to obtain sub-widths of 300 pixels each. The height of the second image is equally divided into 3 parts to obtain sub-heights of 300 pixels each. A total of 9 image blocks of the same size are obtained. Therefore, the size of each image block is 300*300 pixels.

Operation 5012: Perform a filtering operation on the plurality of image blocks to obtain a plurality of partial feature vectors corresponding to the plurality of image blocks, respectively.

In some embodiments, a filtering operation may be performed on the plurality of image blocks through any one of the following filtering operations to obtain the partial feature vectors corresponding to the plurality of image blocks: a Gabor filter bank, linear filtering, non-linear filtering, edge detection filtering, adaptive filtering, wavelet filtering, and morphology filtering.

Exemplarily, using a Gabor filter bank as an example, the Gabor filter bank includes a real part filter and an imaginary part filter. The image block is filtered using the corresponding real part filter and imaginary part filter to obtain a real part value and an imaginary part value. Then, a sum of a square of the real part value and a square of the imaginary part value is calculated, and a square root of the sum is calculated to obtain the partial feature vector corresponding to the image block.

Operation 5013: Concatenate the plurality of partial feature vectors into the second feature vector of the second image.

In some embodiments, the partial feature vectors corresponding to the image blocks are sequentially concatenated according to positions of the image blocks to obtain the second feature vector of the second image.

Exemplarily, if the partial feature vectors corresponding to the plurality of image blocks are a1 and a2, respectively, a mathematical form of the second feature vector of the second image is (a1, a2).

Operation 502: Retrieve an image database based on the to-be-verified feature vector, and use a reference feature vector having a highest similarity to the to-be-verified feature vector as a second target reference feature vector, the image database including reference feature vectors of particular parts in a plurality of pre-registered images.

In some embodiments, FIG. 3O is a fifteenth schematic flowchart of an image processing method according to an embodiment of the present disclosure. Operation 502, i.e., “retrieving an image database based on the to-be-verified feature vector to obtain a reference feature vector having a highest similarity to the to-be-verified feature vector as a target reference feature vector”, in FIG. 3M may be implemented through operation 5021 to operation 5024 in FIG. 3O. Details are described below.

Operation 5021: Convert the to-be-verified feature vector into a first character string.

In some embodiments, elements in the to-be-verified feature vector are sequentially concatenated according to a storage order to obtain the first character string.

Exemplarily, for a to-be-verified feature vector [1, 2, 3, 4, 5], elements are sequentially concatenated according to the storage order into a first character string “1, 2, 3, 4, 5”.

Operation 5022: Convert a plurality of reference feature vectors into a plurality of second character strings, respectively, the first character string and the second character string having a same length.

In some embodiments, elements in the plurality of reference feature vectors are sequentially concatenated according to the storage order to obtain the plurality of second character strings.

Exemplarily, for a reference feature vector [5, 6, 7, 8, 9], elements are sequentially concatenated according to the storage order into a second character string “5, 6, 7, 8, 9”.

Operation 5023: Determine a quantity of different characters at same positions between the first character string and each second character string as a similarity between the to-be-verified feature vector and the reference feature vector.

Exemplarily, if the first character string is 1011101, and any second character string is 1001001, a quantity of different characters at same positions between the first character string and the second character string is 2, which is used as the similarity between the to-be-verified feature vector and the reference feature vector.

Operation 5024: Use the reference feature vector corresponding to the highest similarity as the second target reference feature vector.

In some embodiments, if the similarity between one of the plurality of second character strings and the first character string is greater than the similarity between another second character string and the first character string, a reference feature vector corresponding to the second character string is used as the second target reference feature vector.

Exemplarily, the similarity between the second character string A and the first character string is 0.9, the similarity between the second character string B and the first character string is 0.7, and the similarity between the second character string C and the first character string is 0.5. Thus, the reference feature vector corresponding to the second character string A is used as the second target reference feature vector.

Operation 503: Use a pre-registered image corresponding to the second target reference feature vector as an image belonging to a same object as the second image.

Herein, the pre-registered image corresponding to the second target reference feature vector is used as a pre-registered image having a highest similarity to the second image.

In some embodiments, a local matching policy may further be introduced to perform image matching, that is, the second image is divided to obtain a plurality of first local images. Then, feature extraction is performed on the plurality of first local images to obtain a plurality of first local features. Similarly, the pre-registered image is divided to obtain a plurality of second local images. The size of each second local image is the same as the size of a first local image at a corresponding position. Feature extraction is performed on the plurality of second local images to obtain a plurality of second local features. A plurality of local similarities between the plurality of first local features and the corresponding second local features are calculated through a cosine similarity algorithm. The plurality of local similarities are added. Then, a ratio of the sum to the quantity of first local images is calculated and used as the similarity between the second image and the pre-registered image, thereby finding the pre-registered image having the highest similarity to the second image.

In some embodiments, in a facial recognition scene, it may be detected whether the pre-registered image having the highest similarity to the second image in the image database reaches a preset similarity threshold. If the similarity is higher than a similarity threshold, it is determined that the facial recognition succeeds, otherwise the facial recognition fails.

In this embodiment of the present disclosure, when the particular part included in the first image is in the motion state, the first focus parameter is adjusted to obtain the second focus parameter, and the second image is re-collected based on the second focus parameter to improve the sharpness of the collected image, so that in an image recognition process, image recognition is completed using a second image having high sharpness, thereby improving the accuracy of image recognition.

Exemplary application of this embodiment of the present disclosure in an application scene in which electronic payment is performed in an instant messaging APP is described below.

A scene in which electronic payment is performed through iris recognition is used as an example. An image sensor often collects blurred iris images due to pupil jitter. Consequently, when iris recognition is performed using the iris images, the recognition rate is relatively low. According to the image processing method provided in this embodiment of the present disclosure, the state of the pupil (i.e., the specified position) when an original iris image (i.e., the first image) is acquired may be detected. When pupil jitter is detected through the original iris image, edge detection is performed on the pupil in the original iris image to obtain an edge area of the pupil, and the sharpness of the edge area is acquired. Thus, the first focus parameter is adjusted to obtain the second focus parameter, so as to collect a sharp iris image (i.e., the second image), thereby performing subsequent iris recognition using the sharp iris image and improving the accuracy of iris recognition.

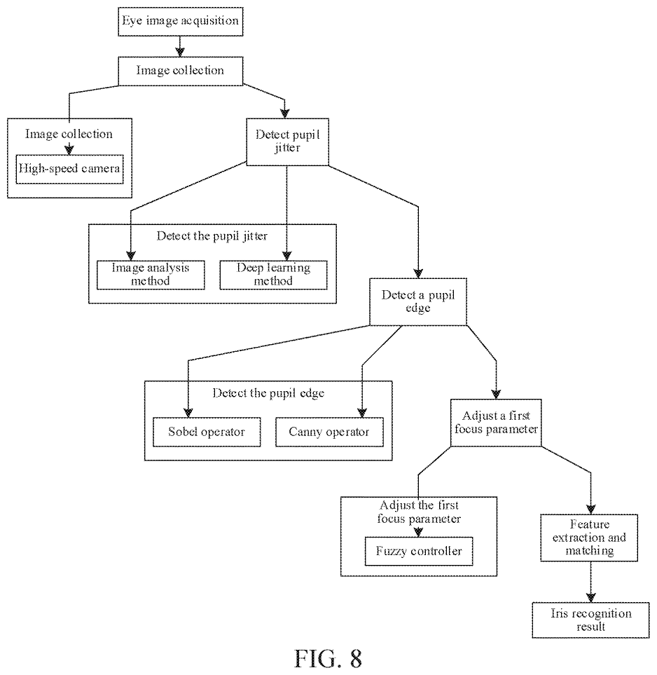

FIG. 8 is an overall architectural diagram of iris recognition according to an embodiment of the present disclosure. A process of iris recognition is divided into five parts, including image collection: responsible for collecting an eye image; detecting pupil jitter: detecting a pupil jitter condition (i.e., a state); detecting a pupil edge: detecting the pupil edge in real time and calculating sharpness; adjusting a first focus parameter: dynamically adjusting the first focus parameter according to an edge detection result; and feature extraction and matching: performing feature extraction and matching on the second image to complete recognition.

A high-speed camera including a complementary metal-oxide-semiconductor (CMOS) image sensor is used in the image collection process. Due to the advantages such as relatively low power consumption, relatively high integration degree, and relatively fast response speed, the CMOS sensor exhibits relatively high performance in real-time image collection application.

When pupil jitter is detected, a graphics processing unit (GPU) and a digital signal processor (DSP) may be adopted to perform parallel computing of image processing and deep learning tasks. The GPU may detect pupil jitter (i.e., the motion state) by calculating a difference and a correlation between pixels in the digital image using an image analysis method. The image analysis method includes an inter-frame difference method and an optical flow method. The inter-frame difference method detects the pupil state by calculating a pixel difference (i.e., a difference between grayscale values of pixels of the first images) between adjacent frames (i.e., every two consecutive first images), and is applicable to pupil jitter detection. The optical flow method estimates the pupil state by calculating a motion vector field of the pupil in an image scene, and has relatively high detection precision. The DSP may detect the pupil state through a deep learning method using a deep learning algorithm of a CNN or a recurrent neural network (RNN). First, a large amount of pupil jitter data needs to be annotated for training a deep learning model. Then, pupil jitter detection is performed on the new eye image data through the trained model to realize automatic recognition.

If pupil jitter is detected (that is, the particular part is in the motion state), pupil edge detection is performed. If pupil jitter is not detected, feature extraction may be directly performed based on the original iris image in the current state.

Pupil edge detection may adopt an edge detection algorithm, such as a Sobel operator and a Canny operator, to realize real-time pupil edge detection. The Sobel operator is an edge detection algorithm, and calculates edge strength based on spatial gradients of an image. The edge is detected by calculating gradients of the image in a horizontal direction and a vertical direction, and then edge strength is determined according to magnitudes and directions of the gradients. The Sobel operator performs convolution operations on the original iris image using two convolution kernels (one is configured for horizontal gradient calculation, and the other is configured for vertical gradient calculation) to obtain a horizontal gradient matrix and a vertical gradient matrix. A gradient magnitude image is obtained by computing a square root of a sum of squares of these two matrices, and binarization is performed on the gradient magnitude image through a set threshold to obtain an edge area. The Canny operator is a multilevel edge detection algorithm, and has advantages in noise suppression and edge detection performance compared with other edge detection algorithms. A detection procedure of the Canny operator is as follows. Smoothing (i.e., a filtering operation) is performed on the original iris image using a Gaussian filter to suppress noise. A gradient magnitude (i.e., a gradient value) and a gradient direction of the original iris image are calculated using the Sobel operator or another similar method. Pixels whose amplitudes are not maximum are suppressed on the edge area using a non-maximum suppression (NMS) technology to obtain a refined edge area. Binarization is performed on the refined edge area using a dual threshold method, that is, two thresholds are set. A strong edge gradient threshold is configured to obtain a strong edge, and a weak edge gradient threshold is configured to connect a weak edge around the strong edge. If a gradient value of a pixel is higher than the strong edge gradient threshold, the pixel is regarded as a strong edge pixel. If the gradient value of a pixel is less than the weak edge gradient threshold, the pixel is regarded as a non-edge pixel. If the gradient value of a pixel is between the two thresholds, the pixel is regarded as a weak edge pixel. Edge detection is finally completed by suppressing isolated weak edge pixels.

To minimize the impact of noise on an edge detection result, the noise needs to be filtered to prevent false detection caused by the noise. To smooth the image, a Gaussian filter is adopted to perform convolution with the original iris image to obtain a smooth image, so as to reduce significant noise impact on an edge detector.

A binary iris edge matrix (i.e., an edge area) is finally obtained. To describe sharpness of an iris edge, sharpness of a pupil edge may be calculated in the following two manners. The sharpness is calculated through edge continuity, that is, an average length of consecutive edge pixels is calculated. The edge continuity may be obtained by detecting connectivity of adjacent edge pixels. Higher edge continuity indicates a more coherent and sharper edge area. The sharpness is a specific value. For example, an edge area is E, a pixel set included in the edge area is P, and a quantity of elements in the edge area is n. Continuity of the edge area may be expressed using the following formula: Continuous (E)=n/N, where Continuous represents a continuity score (i.e., the sharpness), N is a total quantity of pixels included in the original iris image, and n is a quantity of pixels included in the edge area of the original iris image. The sharpness obtained using this formula is a ratio of a quantity of pixels in an edge area to a total quantity of pixels. A larger value indicates stronger connectivity and a sharper edge area of the pupil. The sharpness is calculated through edge compactness: compactness of pixels of the edge area in the original iris image is calculated. The edge compactness may be obtained by calculating density of the pixels in the edge area in various directions (vertical, horizontal, and diagonal). Higher edge compactness indicates a more compact and sharper edge area of the pupil. The sharpness is a specific value. Through the foregoing two manners, sharpness is finally obtained to adjust the first focus parameter.

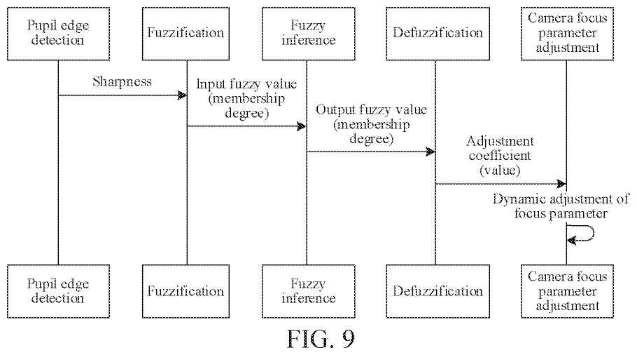

A process of adjusting the first focus parameter may refer to FIG. 9. FIG. 9 is a schematic diagram of a principle of focus parameter adjustment according to an embodiment of the present disclosure. In FIG. 9, a pupil edge detection result, i.e., the sharpness, is inputted into a fuzzy controller to dynamically adjust a first focus parameter. The fuzzy controller is a control method based on fuzzy sets, fuzzy relations, and fuzzy inference, and can process non-linear, time-varying, and uncertain systems. Basic components of the fuzzy controller include: fuzzification, fuzzy inference, and defuzzification.

The fuzzification refers to converting sharpness of an iris edge detection result into a membership degree value in a fuzzy set, that is, converting a precise value into a fuzzy value. For example, a sharpness range (i.e., the preset reference sharpness set) is 0 to 100, where 0 represents completely blurred, and 100 represents very sharp. First, two membership degree functions need to be defined, and the sharpness is mapped to the two fuzzy concepts. It is assumed that for the “sharp” concept, an ascending linear membership degree function may be defined. That is, when the sharpness is 0, the membership degree is 0. When the sharpness is 100, the membership degree is 1. Then, a membership degree function obtained through calculation is: Crisp membership degree=Sharpness/100. Correspondingly, for the “fuzzy” concept, a decreasing linear membership degree function may be defined. That is, when the sharpness is 0, the membership degree is 1. When the sharpness is 100, the membership degree is 0. A membership degree function obtained through calculation is: Fuzzy membership degree=1-Sharpness/100. When the sharpness obtained from the pupil edge detection is 60, a fuzzy concept membership degree corresponding to the sharpness is calculated using the foregoing membership degree function, that is, a crisp membership degree=60/100=0.6, and a fuzzy membership degree=1−60/100 =0.4. The original sharpness 60 is fuzzified into two fuzzy concepts. That is, the crisp membership degree is 0.6, and the fuzzy membership degree is 0.4. In the fuzzification process, the membership relationship of the original sharpness within the two fuzzy concepts is reserved to facilitate subsequent fuzzy inference.

Fuzzy inference refers to calculating, according to a defined fuzzy rule and membership degree function, an output fuzzy value according to an input fuzzy value. The fuzzy rule is a description of a control policy of a system, and includes qualitative analysis on a system effect. It is assumed that there is an output fuzzy concept, that is, a “focus adjustment degree” includes three levels: unchanged, slightly adjusted, and significantly adjusted. First, a group of fuzzy rules needs to be defined. These fuzzy rules describe a relationship between an input fuzzy concept and an output fuzzy concept. For example, if the pupil edge is sharp, the first focus parameter keeps unchanged. If the pupil edge is blurred, the first focus parameter needs to be significantly adjusted. Then, fuzzy inference is performed, that is, an input fuzzy value is converted into an output fuzzy value through these rules. The output fuzzy value may be calculated through fuzzy inference according to the existing membership degree of iris sharpness. For example, if the input is a crisp membership degree of 0.6, the pupil edge is sharp, and the first focus parameter keeps unchanged. In this case, the output is 0.6. If the input is a fuzzy membership degree of 0.4, the pupil edge is blurred, and the first focus parameter needs to be significantly adjusted. In this case, the output is 0.4. Obtained results are a weight of 0.6 (corresponding to “the focus parameter keeps unchanged”) and a weight of 0.4 (corresponding to “the focus parameter needs to be significantly adjusted”), respectively. Then, after the results are visualized as a fuzzy subset, an adjustment degree is between “keep unchanged” and “significantly adjusted”. Finally, a defuzzification process needs to be performed to convert the output fuzzy value into a value again.

Defuzzification refers to converting an output fuzzy value into a precise value for actual control. The defuzzification method may include a centroid method and a maximum membership method. The centroid method is used for outputting a fuzzy value between “keep unchanged” (weight of 0.6) and “significantly adjusted” (weight of 0.4) according to an assigned membership degree value. The centroid method is used for calculating a weighted average value to obtain a final focus adjustment parameter signal (i.e., the adjustment coefficient). A calculation formula of the focus adjustment parameter signal is: (0.6*Value Corresponding to Keeping Unchanged +0.4*Value Corresponding to Significantly Adjusting)/(0.6+0.4 ). Assuming that the value corresponding to keeping unchanged is 0, and the value corresponding to significantly adjusting is 1, a result obtained through calculation is: (0.6*0+0.4*1)/(1)=0.4, that is, the value of the focus adjustment parameter signal is 0.4.

After fuzzification, fuzzy inference, and defuzzification, the first focus parameter is dynamically adjusted. That is, the pupil edge detection result is inputted into the fuzzy controller, and the first focus parameter of the iris camera is adjusted in real time according to the focus adjustment parameter signal outputted by the fuzzy controller. By dynamically adjusting the first focus parameter, the camera focuses according to the adjusted second focus parameter to acquire a sharper second image, so as to ensure the sharpness of the iris image, thereby improving recognition accuracy.

As an example, a calculation process of adjusting the first focus parameter through the focus adjustment parameter signal to obtain the second focus parameter is as follows. Two parameters currentFocus and maxFocusAdjust are first defined, where currentFocus represents a current focus parameter of the camera (i.e., the first focus parameter), such as a current focal length value or a current lens position, and maxFocusAdjust represents a maximum adjustment value that may be reached by the focus parameter of the camera (i.e., the focus parameter step size). The maximum adjustment value may be set according to an actual camera hardware parameter. First, currentFocus is adjusted according to the focus adjustment parameter signal outputted by the fuzzy controller, and a simple linear policy is designed. An amplitude of first focus parameter adjustment is equal to a product of the focus adjustment parameter signal and the maximum adjustment value, that is, Amplitude (i.e., third product)=signalValue (i.e., adjustment coefficient)*maxFocusAdjust. Then, an adjusted focus parameter newFocus (i.e., the second focus parameter) is calculated. The adjusted focus parameter newFocus is equal to a sum of the current focus parameter currentFocus and the amplitude of focus parameter adjustment, which may be represented as: newFocus=currentFocus+signalValue*maxFocusAdjust. For example, currentFocus is 500 micrometers, maxFocusAdjust is 100 micrometers, and signalValue=0.4. Thus, newFocus=500+0.4*100=540. That is, the second focus parameter calculated according to the fuzzy controller is 540 micrometers. Finally, the first focus parameter is dynamically adjusted according to an input pupil edge detection result, thereby ensuring the sharpness of the iris image.

Second image feature extraction refers to extracting discriminative feature information from a sharp iris image (i.e., an image re-acquired by the camera after adjusting the first focus parameter, i.e., the second image). For example, feature extraction is performed using a Gabor filter or in combination with a local binary pattern (LBP). Spatial frequency features (i.e., the feature vector of the second image, to be used as a to-be-verified feature vector) are extracted from the sharp iris image using the Gabor filter, enabling adaptation to small changes in the sharp iris image during pupil jitter. Local texture features (i.e., the feature vector of the second image, to be used as a to-be-verified feature vector) are extracted in combination with the LBP, providing stability and robustness against illumination and scale changes. The second image feature matching refers to comparing the extracted to-be-verified feature vector with an existing reference feature vector in the image database to determine whether the vectors belong to a same pupil. For example, Hamming distance matching is adopted, or a local matching policy is introduced. Hamming distance matching is applicable to binary-encoded feature vectors. That is, the to-be-verified feature vector is converted into a first character string, and a plurality of reference feature vectors are converted into a plurality of second character strings, respectively. The similarity is measured by calculating a quantity of different characters at same positions between the first character string and each second character string. For a case of pupil jitter, weighted Hamming distance matching is performed to assign a higher weight to a key area. The local matching policy is introduced to perform local segmentation on the second image and perform regional matching on local features, thereby improving the robustness of a matching algorithm.

In this embodiment of the present disclosure, the state of the particular part in the first image is detected. If the particular part is in the motion state when the first image is collected, the sharpness of the particular part including the biometric features is positioned by edge detection, and the first focus parameter used when the first image is adopted is adjusted according to the sharpness to obtain the second focus parameter, so as to collect the second image through the second focus parameter, thereby timely and adaptively adjusting a focus parameter collected next time according to the particular part in a previous image and according to the state of the particular part when the previous image is collected. The entire process requires no manual intervention, ensuring that a sharp image may be collected when the particular part is moving, and improving the sharpness of image collection. Image recognition is performed using the second image having high sharpness, to obtain the target image, thereby improving accuracy of image recognition, reducing time costs of repeated collections due to low image sharpness, and improving image recognition efficiency.

The following continues to describe an exemplary structure in which an image processing apparatus 233 provided in the embodiments of the present disclosure is implemented as software modules. In some embodiments, as shown in FIG. 2, the software modules in the image processing apparatus 233 stored in the memory 230 may include:
an acquisition module 2331, configured to acquire a first image including a particular part of a target object, the first image being collected based on a first focus parameter, and the particular part including biometric features of the target object;
a detection module 2332, configured to detect a state of the particular part when the first image is collected; perform, when the state of the particular part is a motion state, edge detection on the particular part in the first image to obtain an edge area of the particular part; and detect sharpness of the edge area; and
an adjustment module 2333, configured to adjust the first focus parameter based on the sharpness to obtain a second focus parameter, the second focus parameter being configured for replacing the first focus parameter to collect a second image including the particular part of the target object.

In some embodiments, when there are a plurality of first images and the plurality of first images are consecutive frames of images, the detection module 2332 is further configured to acquire grayscale values of pixels of the plurality of first images; determine a difference between grayscale values of pixels of every two consecutive first images, and determine an absolute value of the difference; and determine, when absolute values corresponding to more than a preset proportion of pixels in the first image being greater than an absolute value threshold, that the particular part is in the motion state when the first image is collected.

In some embodiments, when there is one first image, the detection module 2332 is further configured to invoke a pre-trained first machine learning model to perform the following processing: extracting a feature vector of the first image; and mapping the feature vector to probabilities corresponding to different states, and determining a state corresponding to a maximum probability as the state of the particular part when the first image is collected.

In some embodiments, before the invoking a pre-trained first machine learning model, the detection module 2332 is further configured to acquire an initialized first machine learning model; acquire a plurality of image samples and real state labels of the plurality of image samples, the image sample including a particular part of a sample object, the particular part of the sample object including biometric features of the sample object, and the real state label representing a real state of the particular part of the sample object; invoke the initialized first machine learning model based on the plurality of image samples to perform prediction to obtain predicted state labels of the plurality of image samples, the predicted state label representing a predicted state of the particular part of the sample object; and determine a state loss value based on the real state label and the predicted state label, and update parameters of the initialized first machine learning model based on the state loss value to obtain the pre-trained first machine learning model.

In some embodiments, the detection module 2332 is further configured to recognize a bounding box of the particular part from the first image, and perform a matting operation on the first image based on the bounding box to obtain a target image corresponding to the particular part; perform a filtering operation on the target image to obtain a smooth image; determine gradient values and gradient directions of a plurality of pixels in the smooth image, the gradient direction including a positive gradient direction and a negative gradient direction; traverse the plurality of pixels in the smooth image, and perform the following operations on a traversed current pixel: filtering out, in the smooth image, adjacent pixels of the current pixel that meet a filter condition, the filter condition including: a gradient value of the current pixel being greater than a gradient value of the adjacent pixel in the positive gradient direction, and the gradient value of the current pixel being greater than a gradient value of the adjacent pixel in the negative gradient direction; and determine the edge area of the particular part based on remaining pixels obtained after the filtering.

In some embodiments, the detection module 2332 is further configured to use, when gradient values of the remaining pixels are greater than a strong edge gradient threshold, the remaining pixels as strong edge pixels, the strong edge gradient threshold being configured for recognizing the strong edge pixel; use, when the gradient values of the remaining pixels are less than the strong edge gradient threshold and greater than a weak edge gradient threshold, the remaining pixels as weak edge pixels, the weak edge gradient threshold being configured to recognize the weak edge pixel; use, when pixels whose distances to the weak edge pixel are less than a distance threshold including at least one strong edge pixel, the weak edge pixel as a target weak edge pixel; and fit the strong edge pixel and the target weak edge pixel into the edge area.

In some embodiments, the detection module 2332 is further configured to determine a quantity of pixels included in the first image as a first quantity; determine a quantity of pixels included in the edge area as a second quantity; and determine a ratio of the second quantity to the first quantity as the sharpness of the edge area.

In some embodiments, the adjustment module 2333 is further configured to determine a membership degree of the first image based on the sharpness, the membership degree representing a probability that the sharpness belongs to a preset reference sharpness set; determine an adjustment coefficient based on the membership degree; and adjust the first focus parameter according to the adjustment coefficient and a focus parameter step size to obtain the second focus parameter, the focus parameter step size being a maximum value of a focus parameter adjustable by an image sensor in a single operation, and the image sensor being configured to collect the first image.

In some embodiments, the membership degree includes a crisp membership degree and a fuzzy membership degree; the crisp membership degree represents a probability that the sharpness belongs to the preset reference sharpness set in a crisp dimension, and the fuzzy membership degree represents a probability that the sharpness belongs to the preset reference sharpness set in a fuzzy dimension. The adjustment module 2333 is further configured to acquire the preset reference sharpness set, the preset reference sharpness set including a plurality of pieces of reference sharpness having different values; determine a ratio of the sharpness to maximum reference sharpness in the preset reference sharpness set as the crisp membership degree; and determine a difference between the crisp membership degree and preset sharpness as the fuzzy membership degree.

In some embodiments, the adjustment module 2333 is further configured to determine a first product of the crisp membership degree and a first preset value; determine a second product of the fuzzy membership degree and a second preset value; determine a first sum of the first product and the second product; determine a second sum of the crisp membership degree and the fuzzy membership degree; and determine a ratio of the first sum to the second sum as the adjustment coefficient.

In some embodiments, the adjustment module 2333 is further configured to invoke a pre-constructed parameter control model according to the adjustment coefficient and the focus parameter step size to adjust the first focus parameter to obtain the second focus parameter.

In some embodiments, when the parameter control model is a linear regression model, before the invoking a pre-constructed parameter control model, the adjustment module 2333 is further configured to acquire an initialized linear regression model, the initialized linear regression model being configured to determine a third product of the adjustment coefficient and the focus parameter step size and determine a sum of the first focus parameter and the third product as the second focus parameter, the adjustment coefficient being an unknown; acquire a plurality of samples, different samples including different combinations of the first focus parameter and the second focus parameter; and substitute the plurality of samples into the initialized linear regression model for solving to obtain the adjustment coefficient, and substitute the adjustment coefficient into the initialized linear regression model to obtain a pre-constructed linear regression model.

In some embodiments, when the parameter control model is a pre-trained second machine learning model, before the invoking a pre-constructed parameter control model, the adjustment module 2333 is further configured to use the first focus parameter, the second focus parameter, and the focus parameter step size as data samples; use the adjustment coefficient as a real coefficient label; invoke the second machine learning model based on the image sample to perform prediction to obtain a predicted coefficient label; and determine a coefficient loss value based on the real coefficient label and the predicted coefficient label, and update parameters of the second machine learning model based on the coefficient loss value to obtain a trained second machine learning model.

In some embodiments, the adjustment module 2333 is further configured to perform feature extraction on the first image to obtain the feature vector of the first image; retrieve an image database based on the feature vector of the first image, and use a reference feature vector having a highest similarity to the feature vector of the first image as a first target reference feature vector, the image database including reference feature vectors of particular parts in a plurality of pre-registered images; and use a pre-registered image corresponding to the first target reference feature vector as an image belonging to a same object as the first image.

In some embodiments, the adjustment module 2333 is further configured to perform grayscale processing on the first image to obtain a first grayscale image; determine a grayscale value difference between any two adjacent pixels in the first grayscale image according to a preset distance and a direction parameter; collect statistics on a quantity of occurrences of each grayscale value difference, and combine a plurality of occurrences into a co-occurrence matrix; extract a plurality of texture features of the first image from the co-occurrence matrix; and combine the plurality of texture features into the feature vector of the first image.

In some embodiments, after the collecting a second image including the particular part of the target object, the adjustment module 2333 is further configured to perform feature extraction on the second image to obtain a feature vector of the second image, and use the feature vector of the second image as a to-be-verified feature vector; retrieve an image database based on the to-be-verified feature vector, and use a reference feature vector having a highest similarity to the to-be-verified feature vector as a second target reference feature vector, the image database including reference feature vectors of particular parts in a plurality of pre-registered images; and use a pre-registered image corresponding to the second target reference feature vector as an image belonging to a same object as the second image.

In some embodiments, the adjustment module 2333 is further configured to divide the second image into a plurality of image blocks; perform a filtering operation on the plurality of image blocks to obtain a plurality of partial feature vectors corresponding to the plurality of image blocks, respectively; and concatenate the plurality of partial feature vectors into the second feature vector of the second image.

In some embodiments, the adjustment module 2333 is further configured to convert the to-be-verified feature vector into a first character string; convert a plurality of reference feature vectors into a plurality of second character strings, respectively, the first character string and the second character string having a same length; determine a quantity of different characters at same positions between the first character string and each second character string as a similarity between the to-be-verified feature vector and the reference feature vector; and use the reference feature vector corresponding to the highest similarity as the second target reference feature vector.

In some embodiments, the adjustment module 2333 is further configured to divide the second image to obtain a plurality of first local images; perform feature extraction on the plurality of first local images to obtain a plurality of first local features; divide a pre-registered image in an image database to obtain a plurality of second local images; perform feature extraction on the plurality of second local images to obtain a plurality of second local features; determine, for each first local feature, a local similarity between the first local feature and a corresponding second local feature; and determine a sum of a plurality of local similarities, determine a ratio of the sum to a quantity of the plurality of first local images, use the ratio as a similarity between the second image and the pre-registered image, and use a pre-registered image having a highest similarity as an image belonging to a same object as the second image.

The embodiments of the present disclosure provide a computer program product. The computer program product includes a computer program or computer-executable instructions. The computer program or the computer-executable instruction is stored in a computer-readable storage medium. A processor of an electronic device reads the computer-executable instructions from the computer-readable storage medium and executes the computer-executable instructions to cause the electronic device to perform the foregoing image processing method provided in the embodiments of the present disclosure.

The embodiments of the present disclosure provide a computer-readable storage medium, having computer-executable instructions stored therein. The computer-readable storage medium has computer-executable instructions or a computer program stored therein. When the computer-executable instruction or the computer program is executed by a processor, the processor is enabled to perform the image processing method provided in the embodiments of the present disclosure, for example, the image processing method shown in FIG. 3A.

In some embodiments, the computer-readable storage medium may be a memory such as a RAM, a ROM, a flash memory, a magnetic surface memory, a CD, or a CD-ROM, or may be any device including one of or any combination of the foregoing memories.

In some embodiments, the computer-executable instruction may be written in the form of program, software, software module, script, or code in any form of programming language (including compilation or interpretation language, or declarative or procedural language), and may be deployed in any form, including being deployed as an independent program or being deployed as a module, component, subroutine, or another unit suitable for use in a computing environment.

As an example, the computer-executable instruction may but may not necessarily correspond to a file in a file system, may be stored in a part of the file for storing other programs or data, for example, stored in one or more scripts in a hyper-text markup language (HTML) document, stored in a single file specially used for the discussed program, or stored in a plurality of collaborative files (for example, files storing one or more modules, a subprogram, or a code part).

As an example, the computer-executable instructions may be deployed to be executed on one electronic device, on a plurality of electronic devices located at one location, or on a plurality of electronic devices distributed at a plurality of locations and interconnected through a communication network.

In summary, according to the embodiments of the present disclosure, the state of the particular part in the first image is detected. If the particular part is in the motion state when the first image is collected, the sharpness of the particular part including the biometric features is positioned by edge detection, and the first focus parameter used when the first image is adopted is adjusted according to the sharpness to obtain the second focus parameter, so as to collect the second image through the second focus parameter, thereby timely and adaptively adjusting a focus parameter collected next time according to the particular part in a previous image and according to the state of the particular part when the previous image is collected. The entire process requires no manual intervention, ensuring that a sharp image may be collected when the particular part is moving, and improving the sharpness of image collection. Image recognition is performed using the second image having high sharpness, to obtain the target image, thereby improving accuracy of image recognition, reducing time costs of repeated collections due to low image sharpness, and improving image recognition efficiency.

The foregoing descriptions are merely embodiments of the present disclosure and are not intended to limit the protection scope of the present disclosure. Any modification, equivalent replacement, or improvement made within the spirit and scope of the present disclosure falls within the protection scope of the present disclosure.

What is claimed is:

1. An image processing method, applied to an electronic device, comprising:
acquiring a first image comprising a particular part of a target object, the first image being collected based on a first focus parameter, and the particular part comprising biometric features of the target object;
detecting a state of the particular part when the first image is collected;
performing, when the state of the particular part is a motion state, edge detection on the particular part in the first image to obtain an edge area of the particular part;
detecting sharpness of the edge area; and
adjusting the first focus parameter based on the sharpness to obtain a second focus parameter, the second focus parameter being configured to replace the first focus parameter to collect a second image comprising the particular part of the target object.

2. The method according to claim 1, wherein
when (i) there are a plurality of first images and (ii) the plurality of first images are consecutive frames of images, the detecting a state of the particular part when the first image is collected comprises:
acquiring grayscale values of pixels of the plurality of first images;
determining a difference between grayscale values of pixels of every two consecutive first images, and determining an absolute value of the difference; and
determining, when absolute values corresponding to more than a preset proportion of pixels in the first image are greater than an absolute value threshold, that the particular part is in the motion state when the first image is collected.

3. The method according to claim 1, wherein
when there is one first image, the detecting a state of the particular part when the first image is collected comprises:
invoking a pre-trained first machine learning model to perform the following processing:
extracting a feature vector of the first image;
mapping the feature vector to probabilities corresponding to different states; and
determining a state corresponding to a maximum probability as the state of the particular part when the first image is collected.

4. The method according to claim 3, wherein before the invoking a pre-trained first machine learning model, the method further comprises:
acquiring an initialized first machine learning model;
acquiring a plurality of image samples and real state labels of the plurality of image samples, the image sample comprising a particular part of a sample object, the particular part of the sample object comprising biometric features of the sample object, and each of the real state labels representing a real state of the particular part of the sample object;
invoking the initialized first machine learning model based on the plurality of image samples to perform prediction to obtain predicted state labels of the plurality of image samples, the predicted state label representing a predicted state of the particular part of the sample object; and
determining a state loss value based on the each of the real state labels and the predicted state label, and updating parameters of the initialized first machine learning model based on the state loss value to obtain the pre-trained first machine learning model.

5. The method according to claim 1, wherein the performing edge detection on the particular part in the first image to obtain an edge area of the particular part comprises:
recognizing a bounding box of the particular part from the first image, and performing a matting operation on the first image based on the bounding box to obtain a target image corresponding to the particular part;
performing a filtering operation on the target image to obtain a smooth image;
determining gradient values and gradient directions of a plurality of pixels in the smooth image, the gradient direction comprising a positive gradient direction and a negative gradient direction;
traversing the plurality of pixels in the smooth image, and performing the following operations on a traversed current pixel:
filtering out, in the smooth image, adjacent pixels of the traversed current pixel that meet a filter condition, the filter condition comprising: a gradient value of the current pixel being greater than a gradient value of the adjacent pixel in the positive gradient direction, and the gradient value of the traversed current pixel being greater than a gradient value of the adjacent pixel in the negative gradient direction; and
determining the edge area of the particular part based on remaining pixels obtained after the filtering.

6. The method according to claim 5, wherein the determining the edge area of the particular part based on remaining pixels obtained after the filtering comprises:
using, when gradient values of the remaining pixels are greater than a strong edge gradient threshold, the remaining pixels as strong edge pixels, the strong edge gradient threshold being configured to recognize the strong edge pixel;
using, when the gradient values of the remaining pixels are less than the strong edge gradient threshold and greater than a weak edge gradient threshold, the remaining pixels as weak edge pixels, the weak edge gradient threshold being configured to recognize the weak edge pixel;
using, when pixels whose distances to the weak edge pixel are less than a distance threshold comprising at least one strong edge pixel, the weak edge pixel as a target weak edge pixel; and
fitting the strong edge pixel and the target weak edge pixel into the edge area.

7. The method according to claim 1, wherein the detecting sharpness of the edge area comprises:
determining a quantity of pixels comprised in the first image as a first quantity;
determining a quantity of pixels comprised in the edge area as a second quantity; and
determining a ratio of the second quantity to the first quantity as the sharpness of the edge area.

8. The method according to claim 1, wherein the adjusting the first focus parameter based on the sharpness to obtain a second focus parameter comprises:
determining a membership degree of the first image based on the sharpness, the membership degree representing a probability that the sharpness belongs to a preset reference sharpness set;
determining an adjustment coefficient based on the membership degree; and
adjusting the first focus parameter according to the adjustment coefficient and a focus parameter step size to obtain the second focus parameter, the focus parameter step size being a maximum value of a focus parameter adjustable by an image sensor in a single operation, and the image sensor being configured to collect the first image.

9. The method according to claim 8, wherein
the membership degree comprises a crisp membership degree and a fuzzy membership degree; wherein the crisp membership degree represents a probability that the sharpness belongs to the preset reference sharpness set in a crisp dimension, and the fuzzy membership degree represents a probability that the sharpness belongs to the preset reference sharpness set in a fuzzy dimension; and
the determining a membership degree of the first image based on the sharpness comprises:
acquiring the preset reference sharpness set, the preset reference sharpness set comprising a plurality of pieces of reference sharpness having different values;
determining a ratio of the sharpness to maximum reference sharpness in the preset reference sharpness set as the crisp membership degree; and
determining a difference between the crisp membership degree and preset sharpness as the fuzzy membership degree.

10. The method according to claim 9, wherein the determining an adjustment coefficient based on the membership degree comprises:
determining a first product of the crisp membership degree and a first preset value;
determining a second product of the fuzzy membership degree and a second preset value;
determining a first sum of the first product and the second product;
determining a second sum of the crisp membership degree and the fuzzy membership degree; and
determining a ratio of the first sum to the second sum as the adjustment coefficient.

11. The method according to claim 8, wherein the adjusting the first focus parameter according to the adjustment coefficient and a focus parameter step size to obtain the second focus parameter comprises:
invoking a pre-constructed parameter control model according to the adjustment coefficient and the focus parameter step size to adjust the first focus parameter to obtain the second focus parameter.

12. The method according to claim 11, wherein
when the parameter control model is a linear regression model, before the invoking a pre-constructed parameter control model, the method further comprises:
acquiring an initialized linear regression model, the initialized linear regression model being configured to determine a third product of the adjustment coefficient and the focus parameter step size and determine a sum of the first focus parameter and the third product as the second focus parameter, the adjustment coefficient being an unknown;
acquiring a plurality of samples, different samples comprising different combinations of the first focus parameter and the second focus parameter; and
substituting the plurality of samples into the initialized linear regression model for solving to obtain the adjustment coefficient, and substituting the adjustment coefficient into the initialized linear regression model to obtain a pre-constructed linear regression model.

13. The method according to claim 11, wherein
when the parameter control model is a pre-trained second machine learning model, before the invoking a pre-constructed parameter control model, the method further comprises:
using the first focus parameter, the second focus parameter, and the focus parameter step size as data samples;
using the adjustment coefficient as a real coefficient label;
invoking the pre-trained second machine learning model based on the image sample to perform prediction to obtain a predicted coefficient label; and
determining a coefficient loss value based on the real coefficient label and the predicted coefficient label, and updating parameters of the pre-trained second machine learning model based on the coefficient loss value to obtain a trained second machine learning model.

14. The method according to claim 1, wherein after the acquiring a first image comprising a particular part of a target object, the method further comprises:
performing feature extraction on the first image to obtain the feature vector of the first image;
retrieving an image database based on the feature vector of the first image, and using a reference feature vector having a highest similarity to the feature vector of the first image as a first target reference feature vector, the image database comprising reference feature vectors of particular parts in a plurality of pre-registered images; and
using a pre-registered image corresponding to the first target reference feature vector as an image belonging to a same object as the first image.

15. The method according to claim 14, wherein the performing feature extraction on the first image to obtain the feature vector of the first image comprises:
performing grayscale processing on the first image to obtain a first grayscale image;
determining a grayscale value difference between any two adjacent pixels in the first grayscale image according to a preset distance and a direction parameter;
collecting statistics on a quantity of occurrences of each grayscale value difference, and combining a plurality of occurrences into a co-occurrence matrix;
extracting a plurality of texture features of the first image from the co-occurrence matrix; and
combining the plurality of texture features into the feature vector of the first image.

16. The method according to claim 1, wherein after the collecting a second image comprising the particular part of the target object, the method further comprises:
performing feature extraction on the second image to obtain a feature vector of the second image, and using the feature vector of the second image as a to-be-verified feature vector;
retrieving an image database based on the to-be-verified feature vector, and using a reference feature vector having a highest similarity to the to-be-verified feature vector as a second target reference feature vector, the image database comprising reference feature vectors of particular parts in a plurality of pre-registered images; and
using a pre-registered image corresponding to the second target reference feature vector as an image belonging to a same object as the second image.

17. The method according to claim 16, wherein the performing feature extraction on the second image to obtain a second feature vector of the second image comprises:
dividing the second image into a plurality of image blocks;
performing a filtering operation on the plurality of image blocks to obtain a plurality of partial feature vectors corresponding to the plurality of image blocks, respectively; and
concatenating the plurality of partial feature vectors into the second feature vector of the second image.

18. The method according to claim 16, wherein the retrieving an image database based on the to-be-verified feature vector, and using a reference feature vector having a highest similarity to the to-be-verified feature vector as a second target reference feature vector comprises:
converting the to-be-verified feature vector into a first character string;
converting a plurality of reference feature vectors into a plurality of second character strings, respectively, the first character string and the second character string having a same length;
determining a quantity of different characters at same positions between the first character string and each second character string as a similarity between the to-be-verified feature vector and the reference feature vector; and
using the reference feature vector corresponding to the highest similarity as the second target reference feature vector.

19. An image processing apparatus, comprising:
at least one memory configured to store program code; and
at least one processor configured to read the program code and operate as instructed by the program code, the program code comprising: an acquisition code configured to cause the at least one of the at least one processor to acquire a first image comprising a particular part of a target object, the first image being collected based on a first focus parameter, and the particular part comprising biometric features of the target object;
a detection code configured to cause the at least one of the at least one processor to detect a state of the particular part when the first image is collected; perform, when the state of the particular part being a motion state, edge detection on the particular part in the first image to obtain an edge area of the particular part; and detect sharpness of the edge area; and
an adjustment code configured to cause the at least one of the at least one processor to adjust the first focus parameter based on the sharpness to obtain a second focus parameter, the second focus parameter being configured to replace the first focus parameter to collect a second image comprising the particular part of the target object.

20. A non-transitory computer-readable storage medium, storing computer code which, when executed by at least one processor, causes the at least one processor to at least:
acquire a first image comprising a particular part of a target object, the first image being collected based on a first focus parameter, and the particular part comprising biometric features of the target object;
detect a state of the particular part when the first image is collected;
perform, when the state of the particular part is a motion state, edge detection on the particular part in the first image to obtain an edge area of the particular part;
detect sharpness of the edge area; and
adjust the first focus parameter based on the sharpness to obtain a second focus parameter, the second focus parameter being configured to replace the first focus parameter to collect a second image comprising the particular part of the target object.
